(19) United States
(12) Patent Application Publication
(10) Pub. No.: US 2003/0177071 A1
(43) Pub. Date: Sep. 18, 2003

(54) System & method for compiling, accessing & providing community association disclosure information, lender information, community association document information and update information

(76) Inventors: Clifford J. Treese, Honolulu, HI (US); Robert M. Diamond, Falls Church, VA (US)

Correspondence Address: REED SMITH LLP, Suite 1400, 3110 Fairview Park Drive, Falls Church, VA, 22042, US

(21) Appl. No.: 10/382,922

(22) Filed: Mar. 7, 2003

Related U.S. Application Data
(60) Provisional application No. 60/362,089, filed on Mar. 7, 2002.

(51) Int. Cl. G06F 17/00; G06F 7/00

(52) U.S. Cl. 705/26; 707/104.1

(57) ABSTRACT

A method for providing information necessary to complete the sale, transfer, financing or refinancing of a housing unit in a community association or to manage the community association, includes: compiling CA information regarding a plurality of community associations into a CA database; extracting the information necessary to complete the sale, transfer, financing or refinancing or to manage the community association from the CA database; and providing to an authorized user the information necessary to complete the sale, transfer, financing or refinancing or to manage the community association. The accuracy of the information extracted from the CA database is offered with a guarantee for certain kinds of errors that may arise.

This application claims the benefit of U.S. Provisional Patent Applications Serial No. 60/362,089 filed on Mar. 7, 2002, the entire disclosures of which are incorporated herein by reference.

### BACKGROUND OF THE INVENTION

1. Field of the Invention

The invention generally relates to a Community Association database with information necessary to complete the sale, transfer, financing or refinancing of a housing unit in a community association (“CA” or “association”) or common interest community (“CIC”), such as a condominium, a cooperative or planned community. Hereinafter, a community association (CA) is refereed as including a CA or a CIC. The database can be complied manually or electronically via an internet-based system (hereinafter Association Information Services, “AIS”). The accuracy of the information extracted form the CA database is offered with a guarantee for certain kinds of errors that may arise.

2. Description of the Prior Art

In the United States, community associations have being developed over the past 150 years. As with many other concepts borrowed from Europe, associations evolved into something uniquely American. In order of historical appearance, the three basic types are:

Planned communities were sporadically developed beginning in the 1820s, received more systematic treatment with J. C. Nichols and the creation of the Country Club district in Kansas City, and came into their own a decade after the Urban Land Institute published The Homes Association Handbook, Technical Bulletin No. 50, in 1964. Planned communities have tended to serve market-rate homebuyers.

Cooperatives were first centered in New York City in the 1880s, and were spawned by immigrant affinity groups and organized labor to provide affordable housing for garment workers and others. Cooperatives have tended to serve low-moderate income (LMI) homebuyers and families. Later, in the 1920s, luxury cooperatives were developed in New York City and spread to other major urban centers such as Chicago and Washington, D.C.

Condominiums were created by nominal common law efforts in the 1950s, but they received a significant boost in 1961 with the passage of Sections 234(c) and 234(d) of the National Housing Act that extended mortgage insurance to project development and unit sales. Condominiums have tended to serve the first-time homebuyer market, empty-nesters and others seeking “carefree living.”

Most associations are developed entirely or predominantly for residential purposes although some may contain non-residential uses, typically commercial activities. At times, planned communities are structured to contain sub-associations comprised of any or all of the three basic types of CAs. These planned communities are generally called Master Planned Communities (MPCs) or Large Scale Associations (LSAs) because of their size and complexity.

Community associations have three core services or functions. First, Community Services-these can include securing trash collection, publishing newsletters, orienting new owners, holding community wide information meetings and scheduling recreational and social support functions. Second, Governance Services—these can include fulfilling obligations required by statutes and governing documents, resolving disputes arising from the enforcement of community policies among residents, administering design review policies and recruiting new volunteer leadership. Third, Business Services—these can include prudently operating the common property, competitively bidding maintenance work, investing reserve funds, developing long range plans, assisting owners in selling or refinancing their homes, assisting buyers in purchasing homes in the association and equitably and efficiently collecting assessments.

By fairly and effectively delivering these services, community associations protect and enhance value: the value of the individual homes (and the lenders' interests in those homes), the value derived from accepting shared responsibilities and performing mutual obligations, and the value inherent in collective participation and decision making at a very essential level—the level of the home.

The following table gives a more complete picture of association growth over the last 30+years. This increase will continue, in large part, because associations accommodate growth in ways that are consistent with smart growth initiatives—they are predicated on density, they require attractive design for marketability and they are organized to meet the fiscal sustainability necessary to support the privatization of infrastructure and municipal service obligations

| | 1998 | 1999 | 2000 | 2001 | 2002 | 2003 | 2004 |
|---|---|---|---|---|---|---|---|
| No. of CAs | 205,000 | 214,000 | 222,500 | 231,000 | 240,000 | 249,000 | 260,000 |
| No. of Units | 16,400,00 | 17,120,000 | 17,800,000 | 18,480,000 | 19,200,000 | 19,920,000 | 20,800,000 |

The financial and related metrics connected with association life and operations are just as impressive. Over 1.2 million volunteers serve on the boards of directors with another 300,000 participating as committee members. There are 230,000 Annual Association Meetings with democratically conducted elections and another nearly 1,500,000 board of director meetings during the year in which owners debate and shape their housing community's future. To assist the board, there are over 500,000 committee meetings during each fiscal year. These boards supervise the collection of over $32 billion in annual assessments and maintain investment accounts of another $35 billion for the long-term maintenance and replacement of commonly held property. Associations provide shelter for nearly 50 million individuals in homes that have an estimated resale value of over $2 trillion dollars. These owners spend another $25 billion on internal home improvements and an estimated $85 billion on mortgage interest and real estate taxes.

Housing is more than just shelter in U.S. society—“homeownership is often thought to be essential to achieve the American Dream”. Residential real estate development has always been subject to cyclical economic, social and political forces. Most recently, these forces have required home builders and developers to cooperate and negotiate more than ever with public bodies and, in some cases, the public itself in order to obtain building permits, design approvals, environmental releases and financing for their projects. These forces, together with demographic changes, and smart growth activities, also have influenced the growth of community associations. Although there are numerous historical reasons for the confluence of these forces, there are four contemporary reasons driving the continued growth and emergence of community associations as the predominant form of ownership housing.

Americans have accepted, for the most part, the collective management structure of community association living. The private covenants and rules characteristic of associations, of course, are not novel in residential living whether rental or ownership. Similar restrictions often exist in rental apartment lease agreements and in zoning laws and building codes that govern traditional single-family detached housing. In traditional single-family housing, however, such restrictions are adopted and administered by public bodies rather than by the private boards of directors that govern community associations.

In some types of community associations, Americans have sought these private controls in return for recreational amenities, clubhouses and social activities. In all types of community associations, however, Americans have accepted these private covenants and rules because collective management and architectural controls are perceived to protect and enhance the value of their largest single investment: their homes.

Local jurisdictions often require builders and developers to create community associations if they want to construct new housing. Because of the local fiscal problems created by rising school populations and voter-imposed limits on real estate tax increases, these jurisdictions require CAs to assume many responsibilities that traditionally belonged to local and state government, such as road maintenance, snow removal and storm water management. For instance, Loudoun County, Va., does not have a public works department. One reason for this is that the county effectively delegates (or privatizes) some of these functions by requiring that developers of residential properties create community associations to fulfill such tasks.

Requiring CAs to provide these public services is one more form of the trend toward privatization. This privatization of public functions has allowed these local jurisdictions to permit continued development of needed housing without having to directly pay for the concomitant infrastructure through the tax base. The developer is now required to build the infrastructure and then create an association to maintain it after development and sales are complete. This type of privatization, also, is consistent with smart growth practices that stress collaboration, density, efficiency and design.

More recently, however, private developers and community development corporations (CDCs) have turned to creating condominiums and planned communities, using equity controls, to provide and maintain LMI ownership housing. Condominium and planned community homes are real property interests, they present fewer title and lien problems, and they are perceived by the public as being “conventional.” In certain jurisdictions, developers of community associations are required, for inclusionary zoning purposes, to include LMI housing within their market rate CA developments. In addition, the conversion of existing multifamily rental apartments and industrial and commercial buildings into condominiums has made ownership more affordable for those desiring to live in urban centers.

Regardless of which type of association is developed or whether it is new construction or a conversion, the homes within these developments have made ownership possible for millions of additional Americans. In part, this increase has been made possible because community association homeownership has matched the demographic changes of the last thirty years—smaller family sizes, more single parent households, more women homeowners and more aging-in-place or NORCs (Naturally Occurring Retirement Communities).

Community associations are housing management vehicles not only for maintaining home values, but, also, for reducing the need for government oversight and minimizing the effects of externalities or social costs. When viewed from a public goods perspective, associations avoid both the “tragedy of the commons,” (where no one is responsible) through mandatory membership and collective management, and the “free rider” problem (where not all beneficiaries pay their share), through mandatory covenants and agreements that require reciprocal actions by both the association (acting through the board of directors) and the homeowners. These factors are consistent with the trend toward privatization of public services and smart growth mentioned earlier—community associations are efficient means of rendering such services, assigning payment responsibility and being responsive to local concerns. The lien-based nature of association assessments gives the community sufficient enforcement abilities such that local government is seldom, if ever, needed to resolve assessment disputes. Although litigation within the civil justice system is used with other association disputes, there is a trend toward the use of various forms of Alternative Dispute Resolution (ADR) in order to more speedily and cost effectively resolve disputes.

The density structure of most CA housing, whether achieved by zoning variances or simple vertical construction, has greatly minimized the sprawl problem that has so recently become a topic of public discussion. It is not altogether ironic that private community associations, by means of a collective management structure and recorded covenants, in fact, do help provide the “decent home(s) and suitable living environment” called for in the Housing Act of 1949. From this perspective, the widespread prevalence of community associations, as an acceptable housing alternative to the traditional single family home, is a one more example of free market efficiencies.

Critics of the growth of community associations usually ignore these four factors and center their attention on issues that have media value such as gated communities and neighbor disputes over fences, bird feeders and similar behavioral issues. Such disputes do exist, but they are few in number and tangential to the actual operations of CAs. The four primary reasons for the growth of associations are either ignored or not understood. It can be argued that community associations represent the greatest single extension of homeownership opportunities since the land grant ordinances enacted early in this country's history, the housing reforms established during the New Deal, and the housing related benefits created for returning World War II veterans. Community associations economically and efficiently provide housing services to nearly 50 million Americans.

A vital component of these housing services involves the sale or resale (transfer), and the financing and refinancing of homes or units within the community association itself. The information and documents necessary to conduct these functions is different from personal credit searches by lenders, requirements faced by real estate agents and brokers to form and close a sales contract and by appraisers to meet mortgage underwriting needs. The sale of a home (or unit) in a community association usually requires assembling various community association documents, collecting information about the association and gathering information about the home (or unit) including the amount of the home's regular assessment, if the assessment has been paid, whether there are any special assessments and whether the home (or unit) has been cited by the association for any architectural control or covenant violations. Collectively, this activity is known as the Association Disclosure Process (Disclosure Process) and the assembled information and documents are called Association Disclosure Information (Disclosure Information).

If the sale or resale of the home in the association involves mortgage financing, then there is also a Lending Process. Similar to the Disclosure Process, the Lending Process in a community association also involves the collection of information and documents. Whereas the Disclosure Process is often driven by statute or contract, the Lending process is more often driven by the underwriting needs of both the mortgage originator and the underwriting needs of the secondary mortgage markets in particular, FannieMae and the Federal Home Loan Mortgage Corporation (FreddieMac or FHLMC. It is important to remember that nearly 40% of all owner occupied housing does not have a mortgage. In other words, Disclosure is necessary part of the transfer of homes in a community association, but lending may not be.

The Buyer requests the Disclosure Information from the Seller of the home. The Seller then turns to the community association (CA) which is required to prepare and deliver this Information to the Seller or the Seller's agent for transmittal to the Buyer in the form of what is generally called a Resale Packet or Transfer Packet. Quite often, a real estate broker or agent requests this Information on behalf of the Seller or Buyer. Quite often, the community manager, if there is one, works with the Seller, the association Board of Directors, and the real estate agent or broker to produce the Information in the form of a Resale Packet. If the association is self-managed, then usually a member of the Board of Directors is tasked with assembling the information. This Association Disclosure Process and Association Disclosure Information are both separate from and in addition to the information that real estate agents and brokers and Sellers must provide to a Buyer regarding the condition of the home (or unit) and similar matters.

Disclosure and Lending Processes, Information, Participants and Information Transactions

The sale of a home (or unit) in a community association usually requires two community association processes: a Community Association Disclosure Process and a Community Association Lending Process. The Disclosure Process, as already mentioned, involves assembling various documents and collecting information about the community association. Information, also, must be gathered about the home (or unit) including the amount of the home's regular assessment, if the assessment has been paid, whether there are any special assessments and whether the home (or unit) has been cited by the association for any architectural control or covenant violations. The assembled documents usually include the declaration, bylaws, budget, rules & regulations, monthly operating statements, audits, reserve studies, design guidelines, various resolutions, insurance certificate for common area insurance and so forth. Most of these documents are not part of the public record and change on a variable basis. This disclosure information is either required by community association statutes, by the association governing documents themselves, by the sales contract or requested by the Buyer (or the Buyer's advisor) so that an informed purchase decision can be made.

FreddieMac's Single-Family Seller/Servicer Guide (Guide) can be ordered on-line at http://www.freddiemac.com/sell/guide/ which helps a Seller/Servicer in the lending industry to comply with FreddieMac's selling and servicing requirements for a CA housing unit, such as underwriting and documentation requirements, mortgage purchase programs and commitment procedures, delivery and eligibility requirements, accounting and investor reporting requirements. In particular, the Seller is required to warrant all the required information. Similarly, FannieMae's Single-Family Guides is available at http://www.fanniemae.com/singlefamily/indexjhtml?p=Single-Family# free of charge through the AllRegs' Online Fannie Mae Single-Family Guides service with FannieMae's eligibility criteria. The guides include Selling and Servicing Guides, including Announcements and Letters, Selling and Servicing Guide Forms, Guide to Underwriting with Desktop Underwriter®, Mortgage Selling and Servicing Contract, and Guidelines for Document Custodians.

The Lending Process involves gathering similar information about both the association and the home. Information that is gathered about the person (the mortgage applicant) is entirely separate and different from the Lending Process Information. Lending can be either for a mortgage or to refinance an existing mortgage. The mortgage lender or mortgage originator, also, may be replaced by a different lender during refinancing. While the information gathered for refinancing is less detailed that in the Lending Process (for the initial mortgage), it still has similar features. In any case, both lending for a mortgage and for refinancing a mortgage require information to be collected and both require similar association documents to be attached. Both types of lending information and accompanying association documents are similar to, but not exactly the same as, those items in the Disclosure Process. This lender information is required not only by the mortgage originator for basic underwriting or by the mortgage refinancing lender for underwriting, but also by the secondary mortgage markets and is used to support their specialized underwriting requirements.

Both the community association Disclosure Process and the Lending Process are separate from, but run in conjunction with or supplement, other types of information collected by a real estate agent, appraiser and others involved in the sale, transfer, financing or refinancing of a home in a community association.

The Disclosure and Lending Processes, in summary, involve collecting and delivering information and documents for four types of primary Information and two types of related Information: The six types of Information are as follows:

| | |
|---|---|
| 1. Disclosure Information: | Required by statute, |
| | contract or requested by a Buyer |
| 2. Lender Information: | Required by a lender for |
| | a mortgage or refinancing a |
| | mortgage or by the secondary |
| | mortgage markets |
| 3. CA Document Information: | Required or necessary such as governing |
| | documents,rule & regulations, financial |
| | reports and similar largely |
| | unrecorded documents. |
| 4. Update Information: | Required because the initial Disclosure |
| | Information or Lender |
| | Information has |
| | become too old to be valid. |

There are two related Information processes:

5. Assessment/Covenant Certificate Required by some lenders for refinancing an existing mortgage for a home in a community association. This gives information about the standing of the homeowner with respect to assessments owed, fines and penalties owed and covenant violations.

6. Architectural/Covenant Inspection Required in some jurisdictions and involves the physical inspection of the home and/or lot to determine if there have architectural changes that are in violation of the recorded covenants. This is not a “home inspection” as it is commonly understood.

As mentioned, this Information may be required, requested or needed for the transfer, sale, resale, financing or refinancing of a home in a community association. The six types of Information are ordered as needed by the Buyer, the current Owner (in the case of a refinance) or others involved in the two processes. When this Information is ordered in any combination, an Information Transaction takes place. In many cases, these Information Transactions involve the payment of fees. These fees are usually paid at the time of the Information Transaction even if the sale, transfer, financing or refinancing is not actually completed. The fee may be collected by a management company as part of its services or by the association itself.

There are usually seven important Participants in the Disclosure and Lending Processes that require some or all of the Information:

Buyer who needs the Information to make an informed decision and to complete the purchase of their home. In a refinance, the current owner resembles the Buyer in terms of these needs.

Seller who has to gather the Information for the Buyer or the Buyer's advisors.

Community Association, acting through its Board of Directors, who must provide the Information to the Seller (or sometimes to the Buyer directly).

Community Association Management (CAM) company or CA manager who will help assemble the Information (in the form of a Resale Packet) for the Buyer, Buyer's advisors or the lender.

Real Estate Broker or Agent who may assist in collecting the Information for the Resale Packet.

Lender making the mortgage or refinancing a mortgage who, in turn, must provide this Information to the secondary mortgage markets.

Current Owner who may be refinancing their mortgage and require Lender Information

There is always a Buyer, Seller and Community Association involved in an Information Transaction. There may not be, however, a Lender or a Real Estate Broker or Agent involved. Once again, each Information Transaction may have a different number of Guarantees depending on the number of Participants, the purpose of that Information Transaction and the type of Information ordered.

The Triggers—Disclosure & Lending Processes

In the Disclosure Process, the Buyer requests the Information from the Seller. The Seller, then, turns to the community association (CA), through the CA's Board of Directors, which is required by statute or local business practice, to prepare and deliver this Information to the Seller for transmittal to the Buyer in the form of what is generally called a Resale Packet or Transfer Packet, or, using AIS terminology, Information. Quite often, a real estate broker or agent, if there is one, requests this Information on behalf of the Seller or Buyer. Quite often, the community association manager or community association management (CAM) company, if there is one, works with the Seller, the Board of Directors, and the real estate broker or agent to produce the Information in the form of a Resale Packet. If the association is self-managed, then usually a member of the Board of Directors is tasked with assembling the Information. In some cases, this Information may have to be updated before closing can occur and title can be transferred.

In the Lending Process, for either obtaining a mortgage or refinancing a mortgage, the lender will request Information after the Buyer (or owner in a refinance) submits a loan application. Usually, the lender, also, will pre-qualify the borrower for creditworthiness before ordering Information.

The Information ordered in both the Disclosure Process and the Lending Process is separate from and in addition to other types of information that real estate brokers and agents and Sellers must provide, by separate statutes, to a Buyer regarding the condition of the home (or unit) and similar matters.

Types of Risks in Disclosure and Lending Processes

Assembling and delivering the six types of Information and related documents carries with it certain risks. The typical types of risks vary depending on the Information, documents and the Participant. For instance, if Disclosure Information is not provided in a timely and complete manner then the Buyer may have a right of contract rescission without liquidated damages. This may involve actual costs for attorneys' fees to prepare initial documents. Once the Buyer takes title, there is a possibility of an unanticipated and unexpected (not reported in the Information) special assessment which is a charge levied by the CA in addition to the regular assessment. The Buyer may also be cited for a covenant violation that originated with the prior owner, but which was not discovered or reported in the architectural estoppel certificate that is part of the Information until after title passed. For instance, a fence may have been erected in violation of the CA's guidelines and the Buyer would now have to bear the expense of removal or re-design. Further, the Buyer may not receive all the unrecorded association documents, such as Design Review Guidelines, erect an improper fence and be forced to remove it as a covenant violation. Also, the Buyer may not be told of a security deposit collected from all Buyers for the clubhouse use. The Buyer may also have to pay allocated common element insurance deductibles because of a large claim that occurs just after taking title.

The lender may have sold the mortgage to the secondary markets based on the Lending Information that contain any of the inaccuracies mentioned above. If the borrower defaults on the mortgage because of these inaccuracies then the secondary markets may have a right to force the originating lender to bear the burden of the loss.

A CAM company may make an error in the assessment estoppel certificate or pay-off letter concerning the Seller. The Seller may have owed $1,700 to the CA and not $170, as erroneously stated in the Information. The CAM would be liable to the CA for the difference. The CA itself may be prevented by statute or contract from collecting a special assessment from a Buyer if the Buyer was told by the CA in the Information that no such special assessment was anticipated. The Real Estate Broker or Agent may incorrectly tell the Buyer in the Information that parking was free or paid for in the regular assessment, when in fact there was a separate charge. A Lender, faced with a cash-strapped borrower, in a lien priority state, may lose the ability to collect any monies from that borrower if the borrower defaults because of the increased financial burdens of a special assessment.

In summary, there are at least 6 types of risks that can be created in the Disclosure Process:

1. Unanticipated or unexpected special assessments that were not reported at closing.

2. Undiscovered covenant violations that were not discovered prior to closing.

3. Assessment estoppel errors for the amount of assessment owed by the seller.

4. Incorrect or incomplete association documents given to the buyer.

5. Failure to be notified of specialized charges.

6. Other general risks such as being faced with an allocated insurance deductible for a common element insured loss.

There are needs for new ways to mitigate these risks.

U.S. Pat. No. 5,781,773 shows a method for transforming and storing data for search and display and a searching system utilized therewith. At least one group of textual data records for the plurality of objects, such as real estate properties, associated with corresponding identifiers is also provided with each group of textual data records including data records having a same or different table mapped format. The system in '773 compiles the information to make them available online, but the information is not necessary for completing the sale, transfer, financing or refinancing of a housing unit in a community association.

U.S. Pat. No. 5,794,216 shows methods and a system for data acquisition in a multimedia real estate database with a device for storing information about a plurality of houses, having various types of information. '216 shares the same deficiencies as '773.

U.S. patent application No. 2001/0047328 shows a method and apparatus for processing escrow transactions which implements, manages, and tracks on-line digital transactions via an escrow, including opening, servicing, real-time or near real time status of a broker, title company, lender, vendor, buyer and seller, and closing of an escrow via a medium such as the internet. '328 includes a lot of agent and legal documents and it emphasizes security. Still, it fails to mention the specific information and document needs for a transaction a housing unit in a CA, including the amount of assessment, whether any legal actions are pending, etc. It also fails to account for the process by which the information and documents are collected. Escrow is basically a repository such that it does not create information.

There are some websites offering piecemeal services. There are none that produce the six (6) Information Transactions and related Reports from a database that can take into consideration real time changes in the information (data and documents) with each Transaction.. Some dot.com websites aggregate static data for the financial services industry, such as posting Board minutes and storing governing documents. None of these websites offer guarantees, real time methods by which to validate or modify critical items in real time, or function as an industry contact for association organizations thereby compiling a CA database and providing statutory disclosure information to complete the sale, transfer, financing or refinancing of a housing unit in a community association.

Similarly, none of these websites have the database ability to create a “Home Prospectus,” “Community Services” or other types of data mining. For instance, a prospective Buyer (or their real estate agent and lender) has no quick way to pre-screen or pre-qualify a CA for lifestyle characteristics or community integration information. For example:

| Home Prospectus | Community Services |
|---|---|
| Quick Snapshot of the Rules & | Community Calendar: e.g., Annual |
| Regulations: e.g., can I have a pet?, | Meeting, Board Meetings |
| can I have a home-based business? | Insurance Obligations: e.g., |
| Quick Snapshot of Finances: e.g., | what does the CA insure and what |
| assessment increase history, | should I consider insuring? |
| growth in reserve funds | |

Neither the CAM manager nor the Board of Directors (BOD) of an association has a way to benchmark, score, compare or evaluate the association with respect to other similar associations. For example:

| Data Mining Budget Builder | Data Mining Salary Survey |
|---|---|
| Queries by type of CA, | CAM companies and CAs |
| size (number of units), | themselves constantly struggle to |
| style (high rise, low rise) amenities, | recruit, hire and retain qualified |
| etc., to allow a reasonable | staff—the Database can assist |
| “apples to apples” comparison | that process. |

In addition, the Information must be collected, maintained and transmitted in a secure, password-protected manner.

Therefore, there are needs for compiling disclosure information, lender information and similar information regarding a plurality of community associations into a CA database, for automating the information compiling process to provide integrated services at one stop, as well as for providing guarantees and real time validation for the accuracy of the information extracted from the CA database.

### SUMMARY OF THE INVENTION

It is a purpose of this invention to compile, access, provide and deliver accurate, relevant, timely, secured and required community association disclosure information, lender information, community association document information, update information, assessment/covenant information, architectural/covenant inspection information (“Information” and “Information Transactions” and “Information Transaction Products”) required in the sale, transfer, finance or refinance of a home in a community association so as to enhance association home values, improve the association's collective management operations, assist in the development of benchmarking and-scoring of association operations, facilitate the privatization of certain of the association's public functions, assist in the expansion of affordable homeownership, minimize social costs and foster market efficiencies in general.

It is another purpose of the this invention to improve the method of delivery in the community association disclosure process (“Disclosure Process) and to improve the financial services process or lending process when a mortgage or refinance of a mortgage in a community association home takes place (“Lending Process”).

It is another purpose of this invention to store, maintain, and access Information needed for the Disclosure and Lending processes, Information Transactions and other purposes in a Community Association Database (“Database”). Further, the Information in this Database will also be warehoused, mined and analyzed for related uses such as developing CA scoring and benchmarking models, facilitating the online completion of applications for certain types of loans, insurance and so forth. The Database also includes a Document Archive that contains those documents necessary to support the processes mentioned above, including but not limited to governing documents, rules and regulations, budgets, monthly operating statements, audits, reserve studies, resolutions, common area insurance certificates and similar documents.

It is another purpose of this invention to use a unique numbering system, Community Association Registration System, to identify community associations by type, number of homes and other attributes so that an accurate census can be developed.

It is another purpose of this invention to provide safe and secure online access by authentication and authorization to the Information, to pay online for the Information Transactions (or get refunded) by credit card, to place an online order for the Information Transactions twenty-four hours a day, seven days a week.

It is another purpose of this invention to provide Guarantees against certain risks in the Disclosure Process to certain users of the Information for certain errors in the Information Transactions, and against unexpected and unanticipated special assessments that may be levied against association home sellers, buyers, current owners, lenders and others who use the Information for their purposes.

It is another purpose of this invention to help community association management companies, onsite managers and self-managed associations to reduce transaction costs, improve load balancing and better integrate the flow of Information and Information Transactions with the increasing electronic data transfer taking place in the mortgage industry and financial services industry.

It is another purpose of this invention to provide an application service program and database by which a community association management company or community association can control the various parts of the Disclosure and Lender Processes and of the different Information Transactions themselves online in its own name such that it can receive online payment for the Transactions, assemble the Information and documents online, modify that Information and those documents in real time for each Transaction and deliver the Information and documents required for the sale, resale , financing and refinancing of homes in community associations.

It is another purpose of this invention to provide a database that functions in real time with validation checks for critical information items, including the ability to print draft Reports before final Reports are sent out, so that each Report and Information Transaction can be as accurate as possible in terms of data and documents.

It is another purpose of this invention to provide steps or stages (New, Prepare, Approval and Approved to issue) by which Reports and Information Transaction are produced in order to minimize errors and increase accuracy of data and documents.

It is another purpose of this invention to permit third parties to go to the website of an AIS Data Partner (management company or association), register and receive a Password (or ID) and then use a Second Party Ordering (SPO) system to access the invention to order and pay for and track information and documents necessary for the sale, resale, financing and refinancing of homes in the association.

It is another purpose of the invention to produce selected aspects of the Information about a given community association as Quik Facts™ that can be accessed online by third parties.

It is still another purpose of this invention to provide an approach consistent with the private market paradigm, long prevalent in American housing, i.e., consistent with over-all functioning of U.S. housing markets.

Several ways are provided via the invention to mitigate the above-discussed risks in a number of ways:

1. By creating guarantees that provide measured protection for the parties to the Disclosure Process for some or all of the risks that are indicated immediately above.

2. By creating a database that functions as part of an application service program so that real time access to the information. (data and documents) required of the Information Transactions can be as complete and as accurate as possible for each type of Report and for each Information Transaction.

3. By creating special data entry conditions under which critical items (necessary to the accuracy of the Reports and the Information Transactions) are validated at the various steps and data entry points used to create each Report, every time a Report is created and in such a manner that the database is continuously updated.

4. By creating special document uploading capabilities as part of a database so that required documents can be uploaded immediately with each Report and Information Transaction

5. By providing the ability for the Database to create draft Reports that can be reviewed for accuracy before the final Report is sent out.

The invention generally relates to a computer-implemented database and internet-based system and method, (an application service program) for compiling, accessing, providing and delivering the six types of Information (and related documents) and Information Transactions (or Information Transaction Products) necessary to complete the sale, transfer, financing or refinancing of a housing unit in a community. The system (hereinafter Association Information Services, “AIS”) compiles the Information in a series of reports that is produced from a database and delivered online. The AIS system and reports also require assembling various documents of association related Information in a Database about the CA and the housing unit in the CA, including the amount of assessment, whether any legal actions are pending, whether special assessments are planned, the nature of planned capital expenditures, special restrictions on use, and similar information required in the association Disclosure and Lending Process in community associations.

In particular, each Disclosure Report is provided with limited guarantees for certain individuals (actual loss incurred without intentional conduct and within one (1) year up to a fixed amount of money, such as $5,000) for the accuracy of the information in the report. The Guarantees are provided for the Buyer, the Board of Directors of the community association, the community association management (CAM) company (if there is one) and the real estate agent or broker (if there is one). The potential users include buyers, sellers, real estate brokers or agents, lenders, secondary mortgage markets, accountants, reserve study specialists, insurance agents and other involved in the community association industry. Information and documents stored and transmitted via the system are securely protected, such as via passwords or the like, except certain types of information may be available to the public as Quik Facts™.

### BRIEF DESCRIPTION OF THE DRAWINGS

The foregoing and additional features and characteristics of the present invention will become more apparent from the following detailed description considered with reference to the accompanying drawings, in which like reference numerals designate like elements and wherein:

FIG. 1 is a flow chart of AIS Business Flow out of the AIS Database as it is used by an AIS Data Partner or someone using the AIS Second Party Ordering according to the invention.

FIG. 2 is a flow chart showing how AIS products (Reports and Information Transactions) are prepared in steps (New, Prepare, Approve, Approved and Issued), assigned a Product Order Number—all from the AIS Database with accuracy and completeness checks based on Critical Item verification and the use of draft Reports according to the invention.

FIG. 3 is a flow chart showing how the AIS Second Party Ordering (SPO) relates to the Database, so that it can be used to order any of the six (6) Information Transactions.

FIG. 4 is a flow chart showing how a Data Partner and User can access a forgotten User ID or Password for Second Party Ordering.

FIG. 5 is a flow chart showing how a User (Third Party or Data Partner) can register and access the Second Party Ordering, and order a product from the website according to the invention.

FIG. 6 is a flow chart showing how to update User information according to the invention.

FIG. 7 is a flow chart showing how the Second Party Ordering queries data concerning the home in a community association from the AIS Database according to the invention.

FIG. 8 is a flow chart showing how the six Information Transaction Products can be selected using the Second Party Ordering according to the invention.

FIG. 9 is a flow chart showing how information concerning a recipient (the one who receives the Information Transaction Product) is entered in the Second Party Ordering according to the invention.

FIG. 10 is a flow chart showing how a product order is confirmed in the Second Party Ordering according to the invention.

FIG. 11 is a flow chart showing how payment is made for a product using the Second Party Ordering according to the invention.

FIG. 12 is a flow chart showing how the status of a product order can be checked in the Second Party Ordering according to the invention.

FIG. 13 is a flow chart showing how Quik Facts™ relates to the Second Party Ordering according to the invention.

FIG. 14 shows a sample of Quik Facts™ according to the invention.

FIG. 15 shows a sample of AIS Assessment/Covenant Certificate according to the invention.

FIG. 16 shows a sample of AIS Disclosure/Resale Plus Information according to the invention.

FIG. 17 shows a sample of AIS Lender Plus Information according to the invention.

FIG. 18 shows a sample of AIS Disclosure/Resale Plus Update Information according to the invention.

### DETAILED DESCRIPTION OF THE INVENTION

An Association Information Services System (AIS System) 10 assigns a CA ID number for each community association. The CA IDs are assigned in a hierarchical manner beginning with a master association, going then to sub-associations and finally tagging the individual units using their recorded numbers. Alternatively, a separate Community Association Registration System (CARS) is established for compiling disclosure information regarding a plurality of community associations into a CA database, which is accessible via the AIS System 10.

The AIS System 10 relies on Data Partners and Community Association Reporters for obtaining the disclosure and lending information. The data in the AIS database 100 are collected by establishing Data Partnerships, the primary method of gathering data. Data Partners include (1) Community Association Management (CAM) companies, (2) large self-managed associations (LSMAs) and large scale master associations (LSAs), and (3) individual smaller self-managed community associations that do not have staff. The first two kinds of Data Partners account for approximately 50-80% of the total number of community association homes (or units) and slightly less than those percentages for the total number of associations. Self-managed associations account for around 20% of the association marketplace. Specific sources of information include but are not limited to the standard lender Uniform Project Questionnaire (or its individual lender equivalent) and the related documents required by lenders and the secondary mortgage markets (FreddieMac and FannieMae) and the primary agencies (FHA and VA) when a mortgage (or refinance) is made in a community association.

Community Association Reporters are independent contractors who are the functional equivalent of inspectors who examine homes for defects. Rather than inspect the physical attributes of a home in an association, however, Reporters collect Information, documents and other relevant association information that are part of the Database and necessary to complete an Information Transaction 131, such as a Disclosure Report, a Lender Report, an Update Report, a CA Document Report, an Assessment/Covenant Certificate Report, or an Architectural/Covenant Inspection Report. Reporters are recruited from CAM company staff, association members, real estate industry professionals, appraisal industry professionals and other organizations.

The AIS System 10 also collects and compiles disclosure information from areas other than the Disclosure and Lending Process, such as businesses and government agencies (e.g., land records, etc). The AIS database 100 or the CA Database alleviates the expense a number of businesses and government agencies now go through to verify exact addressing, facilitates technological modernization of land records through an electronic land title registration system, tags residential ownership property that has no mortgage, provides an accurate and unified hazard ID program for flood and other perils, and provides an umbrella system for the variety of coding systems used by county property tax assessors.

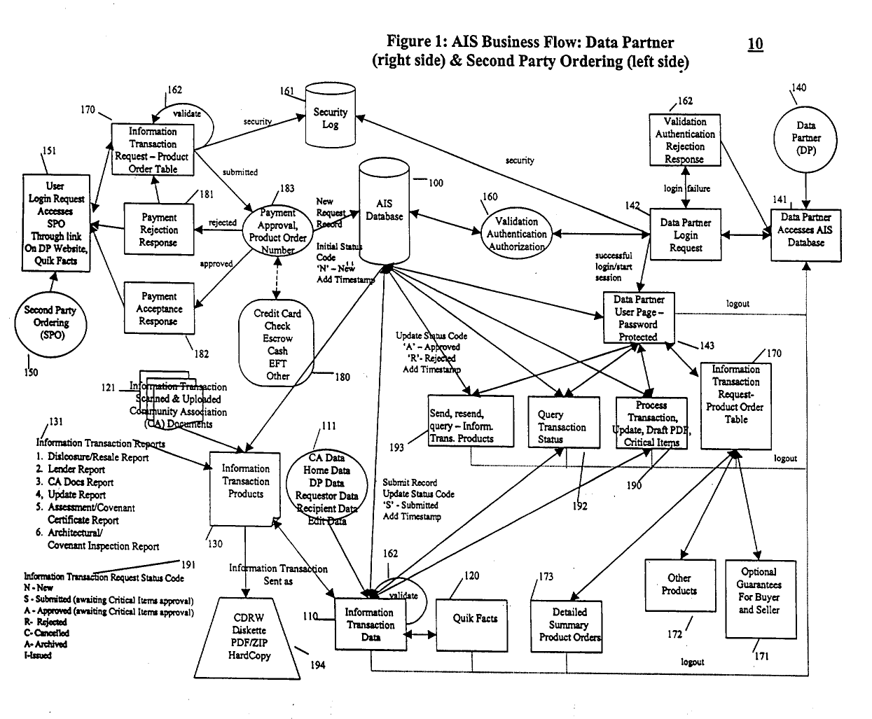

The AIS System 10 allows the AIS database 100, i.e., a comprehensive Database, to be accessible through a user interface for users including an owner or potential purchaser of the housing unit, a real estate broker or agent, a lender in the first or secondary mortgage market, an accountant, reserve study specialists, an insurance agent, a manager or a Board of Directors of a community association, and AIS Data Partners and their associates, etc., to conduct online certain Disclosure and Lender Processes necessary to complete the sale, transfer, financing or refinancing of a housing unit in a community association. The information so provided by the AIS System 10 is automatically compiled from Information Transaction Data 110 to produce Information Transaction Reports 131. These Reports, in turn, are combined with Information Transaction Community Association (CA) Documents 121 to produce Information Transaction Products 130. The Information Transaction Data 110 is collected from several sources 111 including home data and so forth. The Information Transaction CA Documents 121 are scanned and uploaded into the AIS Database 100. All the potential users listed above can request the AIS System 10 to generate an AIS Disclosure Report and other Information Transaction Products 130 according to the flow chart depicted in FIG. 1.

Each AIS Data Partner 140 is allowed to order information from the AIS database (step 141) after the login process (step 142) for a fee or for free based upon its agreement with the AIS system 10. Each AIS Data Partner 140 and the users affiliated with such a AIS Data Partner 140 are assigned an ID number and a secure password to provide different levels of access to the AIS Database 100.

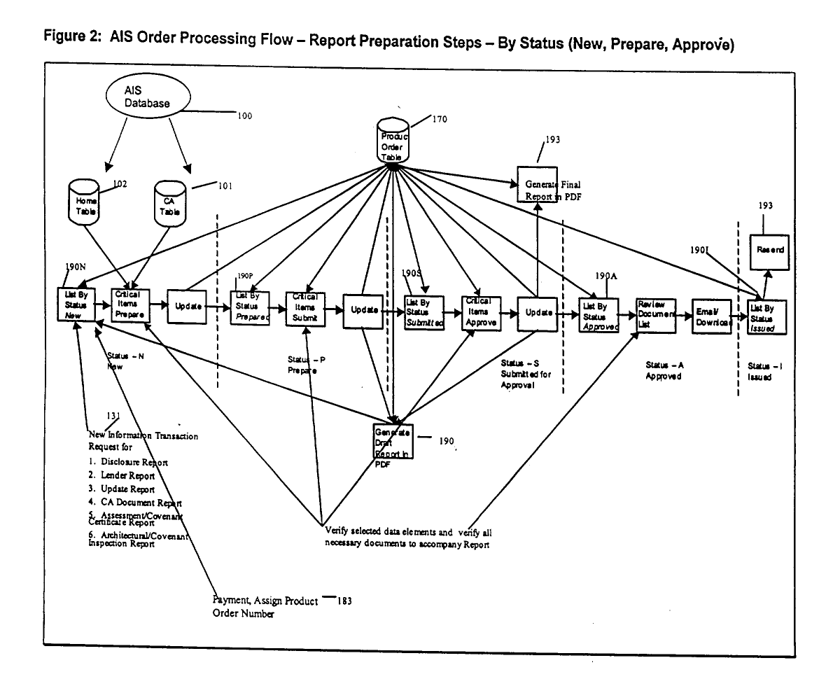

The users and the Data Partners 140 access the AIS Database 100 mainly through the Internet via an application service program in real-time. The AIS Database 100 is available 24 hours a day and seven days a week. The AIS System 10 also takes orders by telephone, faxes and online through Second Party Ordering. To insure the integrity, accuracy and completeness of the Information Transactions, the AIS System 10, as shown in FIG. 2, provides for a one-step or a multi-step process to produce the required Information. This allows for verification and actual examination of the data and documents in the various steps of their production. This verification procedure is enhanced because Critical Items 190, which are necessary to the production of the Information Transaction Products 130, must be verified before an Information Transaction Report 131 (and the related Information Transaction CA Documents 121) can be sent (step 193). Further, a draft of the Report can be viewed before it is sent. The AIS Database, 100 together with its online product ordering function for the Information Transaction Products, 130 allows for multiple payment methods 180 (e.g., credit card, check and so forth) as depicted in FIG. 1 and for multiple delivery methods 194 (e.g., e-mail, hard copy, compact disc, floppy disk, and so forth).

The data 110 stored in the AIS Database 100 may be in relational form, as it is in these Figures, with tables, entries and records linked by indices and keys, or it may be embodied at another time as a collection of objects in an object-oriented database. The AIS Database 100 is located on a server-based engine that is protected by password and User ID 143.

The purpose of the AIS Database 100 is to maintain data 110 and documents 121 that are required and necessary to produce Reports 131 and deliver Information Transaction Products 130 (Reports 131 and Documents 121) used in the sale, resale, financing and refinancing of a home in a community association (CA)—a condominium, cooperative or planned community. These Information Transactions 131 are produced as Reports (with certain exceptions) and are used by purchasers, sellers, current owners, real estate professionals and lenders. The description of this invention uses both the terms “Information Transaction” and “Information Transaction Product” interchangeably. The Information Transaction Products 130 are usually ordered by sellers for prospective buyers, by real estate professionals on behalf of sellers and by lenders on behalf of buyers for a purchase of a home or by current owners if a refinance of a mortgage is involved.

Generally, then there are at least six (6) types of Information Transactions 131 that may take place in the sale, resale, financing, or refinancing of a home in a community association. These are Disclosure Reports, Lender Reports, CA (Community Association) Document Reports, Update Reports, Assessment/Covenant Certificate Reports and Architectural/Covenant Inspection Reports.

Although the seller is usually responsible for some Information Transactions 131 such as Disclosure Reports (short for Disclosure/Resale Report), the actual production of the Report may be delegated to a manager or management company. In self-managed communities (without staff), a member of the board of directors usually is responsible for preparing and delivering the Report. The other types of Information Transactions 131, such as the Lender Report, are also generally produced in the same manner. An Update Report is used if the information in the Disclosure Report becomes stale-dated. CA Documents are usually required to be produced with Disclosure and Lender Reports although they are sometimes produced separately. The Architectural/Covenant Report is part of the Disclosure Report. The Assessment/Covenant Certificate Report is used by a current owner to refinance a home in the community association.

The data 110 in the AIS Database 100 is divided into several data categories 111: Community Association Data, Home Data, Data Partner (DP) Data, Requestor Data, Recipient Data, and Edited Data. Community association data is specific data for a given community association, which includes data elements required by community association disclosure laws in different states, disclosure requirements of community association governing documents, requirements of mortgage lenders, requirements of secondary mortgage markets (such as FannieMae and FreddieMac), and requirements of sales contracts. Home Data is specific data for a given housing unit. DATA PARTNER Data is specific data for a given Data Partner 140. Requestor Data is specific data for a given Information requester. Recipient Data is specific data for a given Information recipient. In most states, if the Information Transactions 131 are not delivered in a timely manner, a prospective purchaser may have a right to cancel a sales contract without penalty or the purchaser may not have to pay an undisclosed special assessment.

Typically, the data 111 deals with the delivery of three core housing services by the community association: business services, governance services and community services. Some of the data elements, such as litigation, disputes, governmental notices, reserve funds and collections, are variable such that they may change every time there is an Information Transaction 131. If such a change is not accurately known, it may adversely impact a purchaser of a home in a community association. For instance, the association may be planning a significant special assessment or the association may be planning to litigate with the developer. Both such actions could be very expensive. If a prospective purchaser knows about that information before purchase, then the prospective purchaser can make an informed decision. This variable and important data is referred to as a Critical Item. The Critical Items are mainly stored in the categories of CA data or home data, such as how much the seller owes the association, the existence of rights of first refusal, the status of litigation, anticipated special assessments and capital expenditures as well as key use restrictions, parking issues, and similar items. As shown in FIG. 2, the AIS Database 100 makes provision for reviewing Critical Items 190 at various steps, such as 190N, 190P, and 190S (as discussed later) in the process of creating any of the Information Transactions 131.

The Information Transactions Data 110 are compiled from the data 111 stored in the AIS database 100 then formatted into the Information Transaction Reports 131 or Quik Facts 120 in a custom-formatted manner, such as Quik Facts 120. The AIS system 10 also extracts from those traditional information transaction documents 121 generated by community associations that are specific for a given community association by scanning (step 121) them into the AIS Database 100 or uploading them via the Internet into the AIS Database 100. The traditional information transaction documents 121 range from recorded instruments such as declarations, bylaws and articles of incorporation to unrecorded instruments such as budgets, reserve studies, rules & regulations, insurance certificates and association notices. Like the data 111, these traditional information transaction documents 121 may also be variable, changing annually or adopted at various times by the community association's board of directors. Because timeliness and accuracy is crucial in creating and delivering the Information Transactions Reports 131 or the Quik Facts 120, the AIS system 10 has an upload function 121 and an edit function to the Critical Items embedded in the traditional information transaction documents 121 to facilitate updating the data 111. The edit function also allows any Data Partner 140 continually and in real-time to access the system to update the data 111 in the AIS Database 100.

As mentioned, each Data Partner (DP) 140 has a contract to use the AIS system 10 and to establish the AIS database 100 thereby facilitating the production of Information Transaction Products 130. A Data Partner is usually a community association management (CAM) company or an individual self-managed community association. A CAM company manages numerous community associations under contract and is responsible for assisting the board of directors in delivering the three core services including the production and delivery of Information Transaction Products 130. The Data Partners 140 are responsible for entering Information Transaction Data 110 and loading the traditional information transaction documents 121 into the AIS Database 100. The Data Partners 140 are also responsible for continually updating the information they provide to the AIS Database 100. As part of the contractual relationship, each Data Partner 140 is provided with a User ID and Password 143 for a specific part or level of access to the AIS Database 100 such that they can also facilitate the production and delivery of Information Transaction Products 130 via their own webpage or other channels.

Access to the data 111 in the Information Transaction Data 110, the Information Transaction Documents 121, and the Quik Facts 120 is protected by validation, authentication and authorization processes 160. The validation, authentication and authorization processes 160 are performed by a security log 161. Any login failures 162 are also recorded in the Security Log 161. The AIS Database 100 applies commercially available encryption and security standards for such a process. Each Data Partner 140 may change its User ID and Password 143 via the Internet at any time.

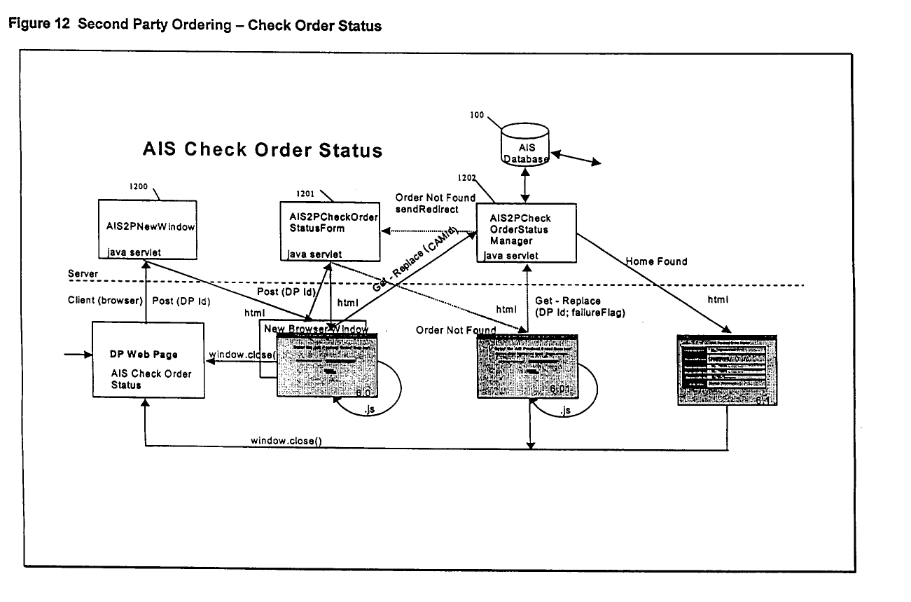

Any of the Information Transactions 131 can be ordered via two channels. One channel is to order directly from a Data Partner with the AIS system 10 via the AIS website, i.e., First Party Ordering. The second channel is when a third-party User goes to order through a Data Partner 140 by going to the Data Partner's website. indirectly ordering or Second Party Ordering 150. The direct route is depicted in FIG. 1 (right side) and FIG. 2, while the indirect route is depicted in FIG. 1 (left side) and FIGS. 2-12.

A user may call, fax, visit or otherwise directly contact the staff or member of the AIS system 10 or a Data Partner (First Party Ordering) to make a request for an Information Transaction 170. Alternatively, a User may use Second Party Ordering 150 by logging-in to the Data Partner's website 151 and making a request for an Information Transaction 170. This request begins with step 190 then proceeds to various steps 190N, 190P, 190S, 190A and 1901 in FIG. 2 before it is ready to be sent via step 193. As part of the first step 190N, a fee 180 is collected and a product order number 183 is assigned for tracking purposes. All of the Information Transactions 131 are charged with a fee which is payable online by credit card or by other means 180. If a fee payment has been rejected (step 181), the process stops entirely. If the fee payment is accepted (step 182), the request is processed further and a product order number 183 is assigned. The product order number 183 is assigned to each of the Information Transactions 131 to be used at steps 190N, 190P, and 190S in FIG. 2 that lead to the sending of the Report 193. The Second Party Ordering follows a slightly different route and will be discussed later.

The major steps of the direct route: Update, Draft PDF 190, Query Transaction Status 192, and Send Information Transaction Products 193 are also in FIG. 1. The Query Transaction Status 192 represented by status codes 191: as New, Submitted, Approved, Rejected, Cancelled, Archived, or Issued. In FIG. 2, the steps are listed as New 190N, Prepared 190P, Submitted 190S, Approved 190A and Issued 1901. In the Step 190, the AIS system 10 updates the data 111 in the AIS Database 100 at any time during the processing of the Information Transactions with the edit function to edit all contents or just the Critical Items. The edit function allows each Data Partner to edit any particular data element in that portion of the AIS Database 100 to which it has password access including adding and subtracting community associations, homes within the association (for new construction) and so forth. Each of the aforementioned steps in FIG. 2 has a Critical Items and Update function. This continuous ability to update data is vital for the accuracy of the AIS Database 100 and the Transaction Information 131. This continuous ability to update data is in steps so that the Data Partner may provide for different staff to control the data examination using different logins. This type of role allocation is further protection for the accuracy of the data. Further, all of the data depicted in 111 may be edited in real time by the Data Partner at any of the steps in the preparation process 190.

In FIG. 2, in the first step, the New 190N Product Request step, the information is gathered concerning the home being sold, re-sold, financed or refinanced. In the New Product Request 190N step, a CA Table 101 and a Home Table 102 is compiled from the AIS Database 100, as an example. The information in this first step of processing includes the name of the community association in which the home is located, the address of the home, the Recipient name (and similar identifying information) and the Requestor name (and similar identifying information). Payment 180 is also made for the Information Transaction and optional Guarantees 171 and related products 172 may be purchased at this time. The Disclosure component of the Information Transaction 131 includes insured Guarantees for the Buyer, the Board of Directors, the manager (if there is one) and the real estate agent/broker (if there is one). These Guarantees are protection against unexpected and unknown special assessments, covenant errors, estoppel errors, association charge errors and other similar errors. Both the Buyer and Seller can purchase certain optional Guarantees 171 for special assessment protection in the first step 190N.

In the second step, the Prepared 190P product processing step, the Critical Items are reviewed again for their accuracy and changes may be updated or edited. In the third step, the Submitted 190S product processing step, the Critical Items may be examined by a different person. This step is optional such that the user or a Data Partner may elect to omit this step because of lack of available staff or other reasons.

In the fourth step, the Approved 190A product processing step, all of the Information Transaction Documents 121 are reviewed. The Data Partner may need to modify, add or delete Information Transaction Documents 121 in this step because certain documents may have expired (such as the CA insurance certificate) or because a new document needs to be added (such a new CA resolution on pets in the community). This can be done with the edit function or with the upload function depending on need. If certain Information Transaction Documents 121 are not required for a particular Report, they can be unchecked and not sent out. Once again, this helps to maintain the real-time accuracy of the AIS Database 100 thereby ensuring that the Information Transaction is as accurate as possible.

In the last step, the Issued 1901 processing step, the Information Transaction is sent (or resent) 193 usually by email with a compressed file attachment that includes the particular Report for the Report and CA Documents although other means of delivery may be used 194. The final version of the Report is preferred in a PDF format to protect the information from being changed by anyone once it has been received. The attached Information Transaction Documents 121 usually have been scanned in and/or uploaded as PDF documents as well although this may not be the case for each document. The Report 131 and the Documents 121 are combined into an Information Transaction Product 130 to be ordered and delivered.

At each step of the Information Transaction 131, the Data Partner can query (192 step) the AIS Database 100 to determine the progress of the product order 170. The product order number 183 is also used to query the status 191 of Information Transaction product processing. Each of the processing steps 190N, 190P, 190S and 190A is time-stamped in the AIS Database 100. In some jurisdictions, Disclosure Reports often have to be delivered within a certain number of working days after they are ordered or requested. Once the Information Transaction product has been issued (step 190I), it may have to be resent for some reasons and this is accomplished immediately by email with a compressed file attachment for the Report 131 itself and the accompanying CA Documents 121. If an Information Transaction Product 130 is processed without delivery, it has been either Rejected or Cancelled. If it has been issued, then it is kept in an archive for later reference or audit purposes.

The AIS system 10 provides the user or the Data Partner with the ability to query the status of the Information Transaction during processing. During this query, the Data Partner or User can see that the Information Transaction is time-stamped and date-stamped at each step. The AIS system 10 also can produce for the Data Partner draft PDF versions of each Report at each step of the processing so that a hard copy can be reviewed for accuracy and completeness. In errors are found, then the edit or Critical Items functions can be used to make corrections.

The Second Party Ordering System (SPO) 150 is now described below. In the SPO, a User goes to the website of a Data Partner either to order an Information Transaction or to view the Quik Facts™ 120. The Quik Facts™ 120 is incorporated into both the First Party Ordering and the Second Party Ordering 151. Quik Facts™ is a snapshot of the community association produced from the AIS Database 100 so that it always contains the most current information. The Quik Facts™ 120 include the name of the community, the number of units, its annual budget, a brief list of rules and similar information. In the direct route, Quiks Facts™ 120 can be viewed by the Data Partner in the edit function. In the SPO, Quik Facts™ 151 can be viewed on the website of a Data Partner.

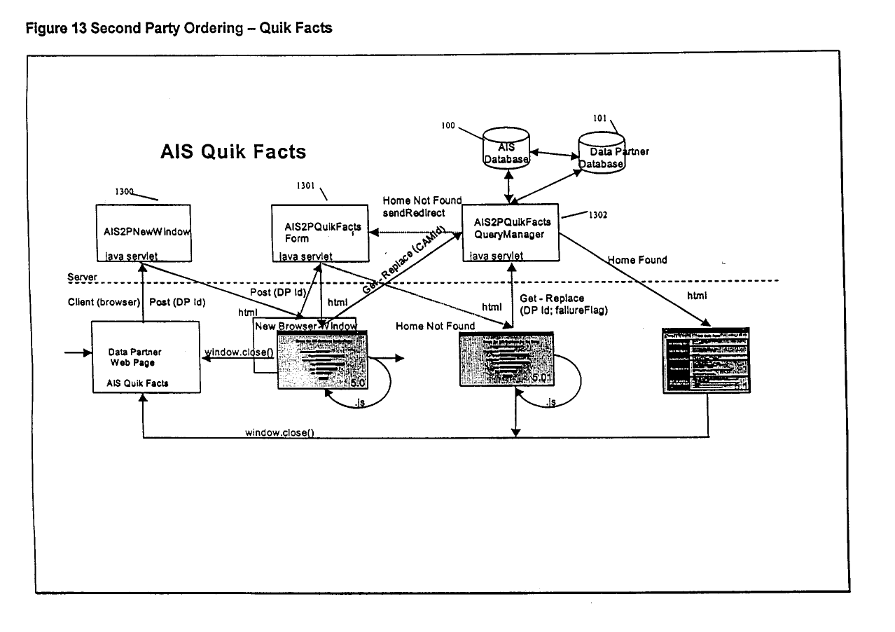

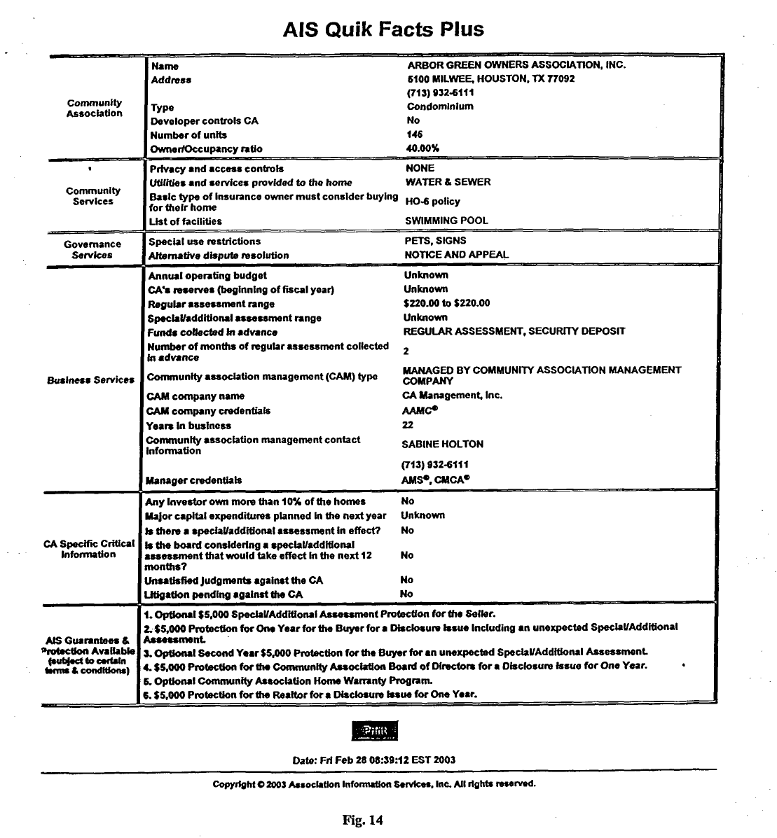

The User, in the SPO, is anyone that goes to the website of a Data Partner to view Quik Facts™ 120 or to order an Information Transaction Product 130. A typical User would be a prospective home purchaser looking for summary information about a community association or a buyer, real estate agent or broker or lender who wants to order online an Information Transaction Product 130. Quik Facts™ for a given community association can be viewed through a link on the Data Partner's website that connects to the AIS Database 100 as depicted in FIG. 13 1301. The User must be able to provide certain identifying information such as the name of the community, the address of a particular home and zip code in order to access Quik Facts™, again, as depicted webpage 5.1 in FIG. 13 or its enlarged version in FIG. 14.

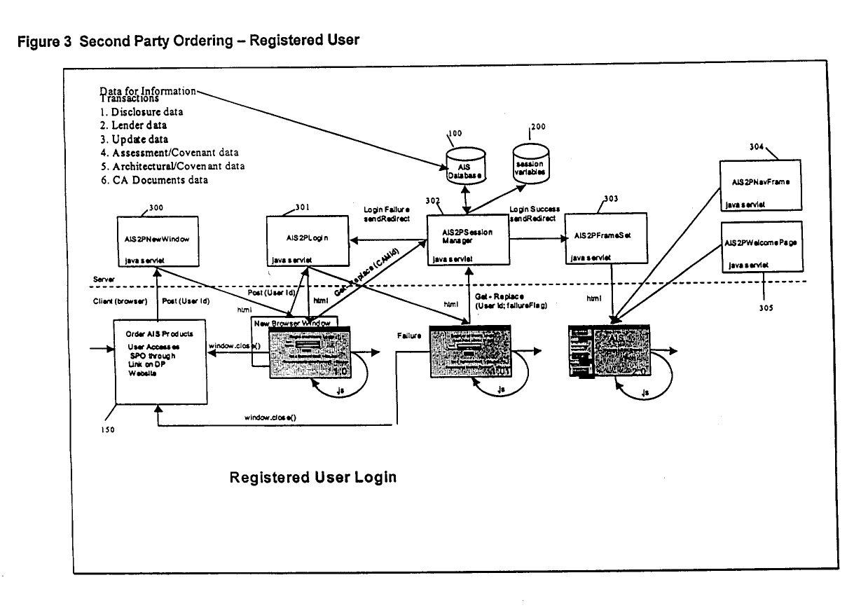

If the User wants to order an Information Transaction Product 130, then the User must login 151 and go through a similar authentication process 160 used with First Party or direct ordering. The User is validated by their email address and an ID (or Password). Once logged in, the User then proceeds through the online steps to order an Information Transaction Product 130 as depicted in FIGS. 3 through 12. A link is put on the website of the Data Partner so that a third party can click on it to order any of the Information Transaction Products. Second Party Ordering, because it is integrated with the AIS Database, provides the same security, validation checks and Critical Item checks as those in FIG. 1 and FIG. 2. Before a Data Partner can send out a Report that has been ordered using the Second Party Ordering system, the Data Partner must complete the Critical Items review and the document review. Once a Disclosure Report is sent out, it is backed by an insured guarantee against damages that may arise from certain inaccuracies for one year from the date of the Disclosure Report. The types of inaccuracies that could lead to money damages include unexpected and unanticipated special assessments, covenant errors, estoppel errors, association charge errors and similar mistakes.

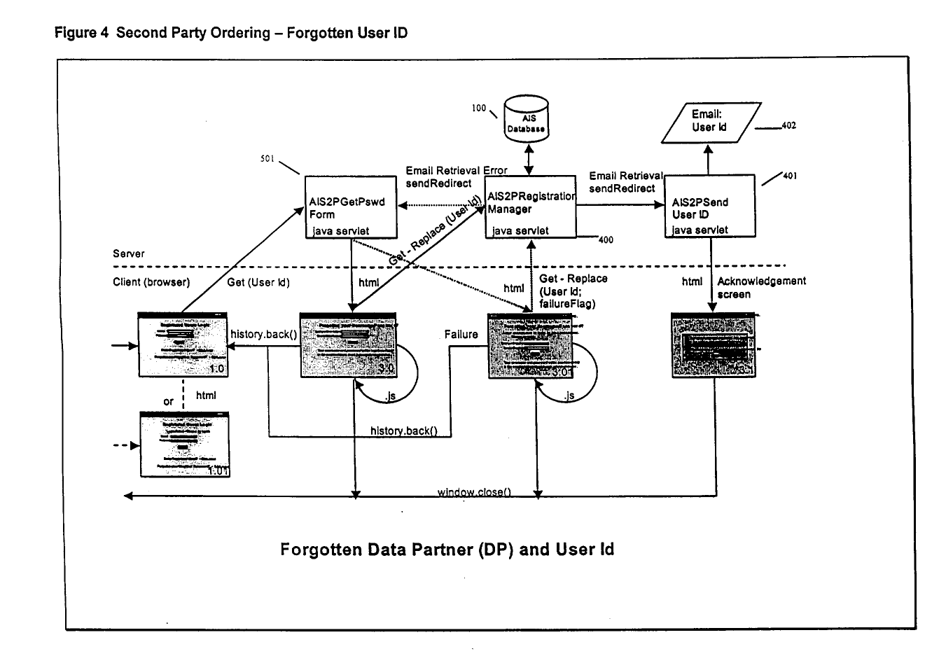

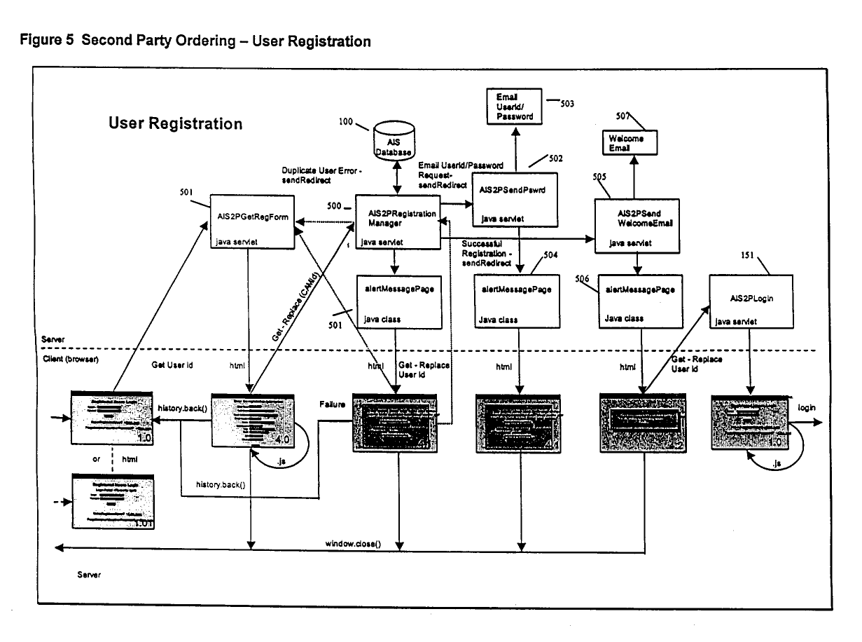

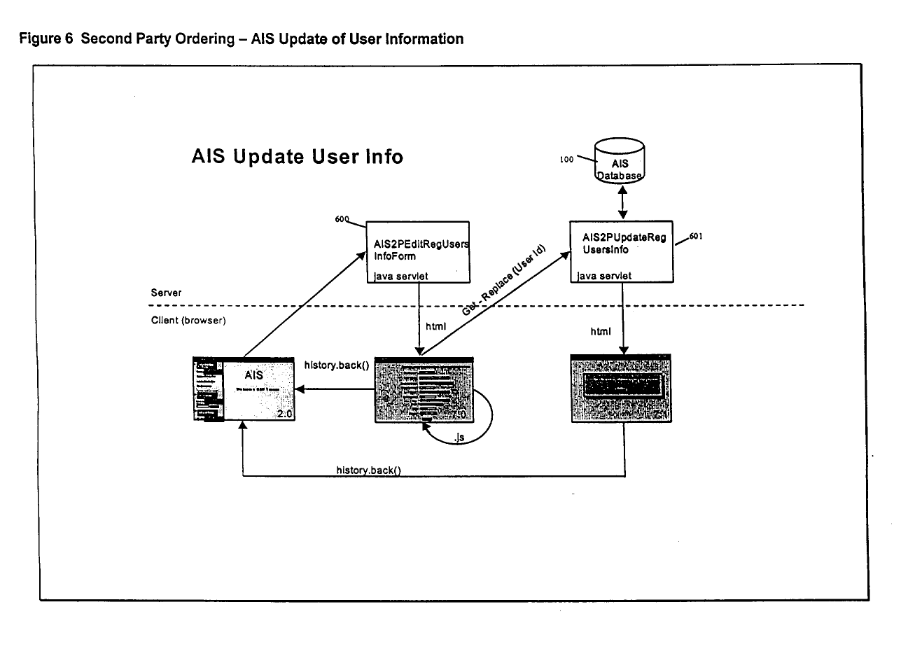

The session variables 200 in these FIGS. 3-12 are the dynamic elements defined in the AIS Database 100 and related to Java™ servlets and related components. A new User must register according to the flow chart in FIG. 5 so as to be able to login according to the flow chart in FIG. 3. Once registered, if the User forgets the ID (or Password) and needs it to be sent, this can be accomplished according to the flow chart in FIG. 4. If the User needs to change certain identifying information in the registration, this can be accomplished according to the flow chart in FIG. 6.

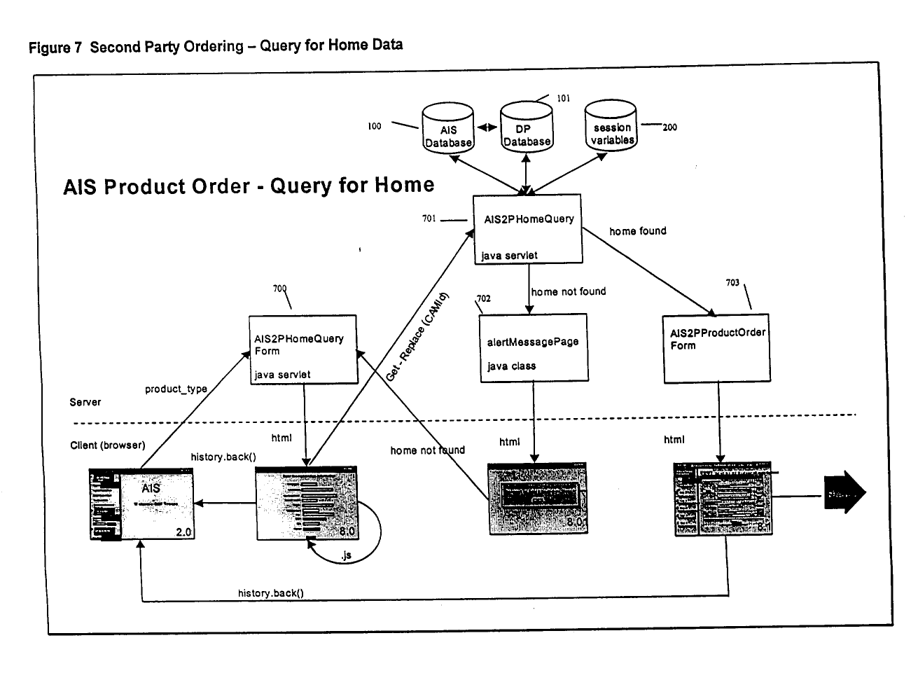

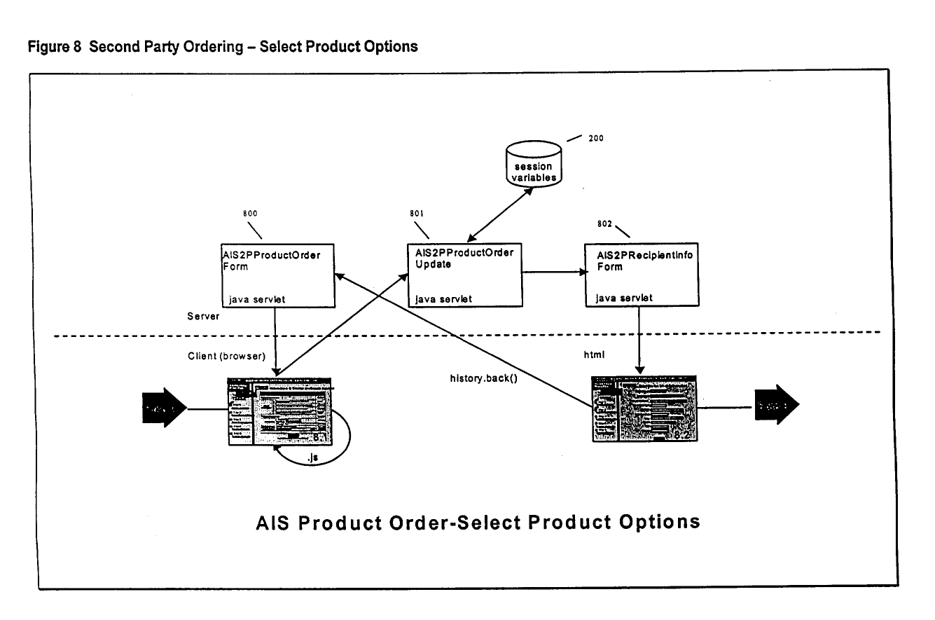

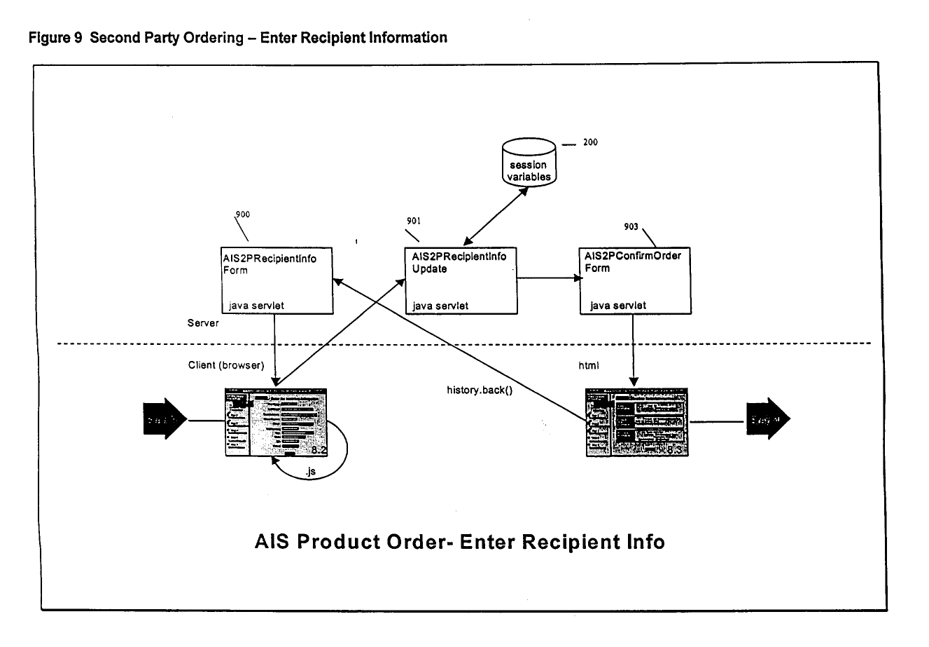

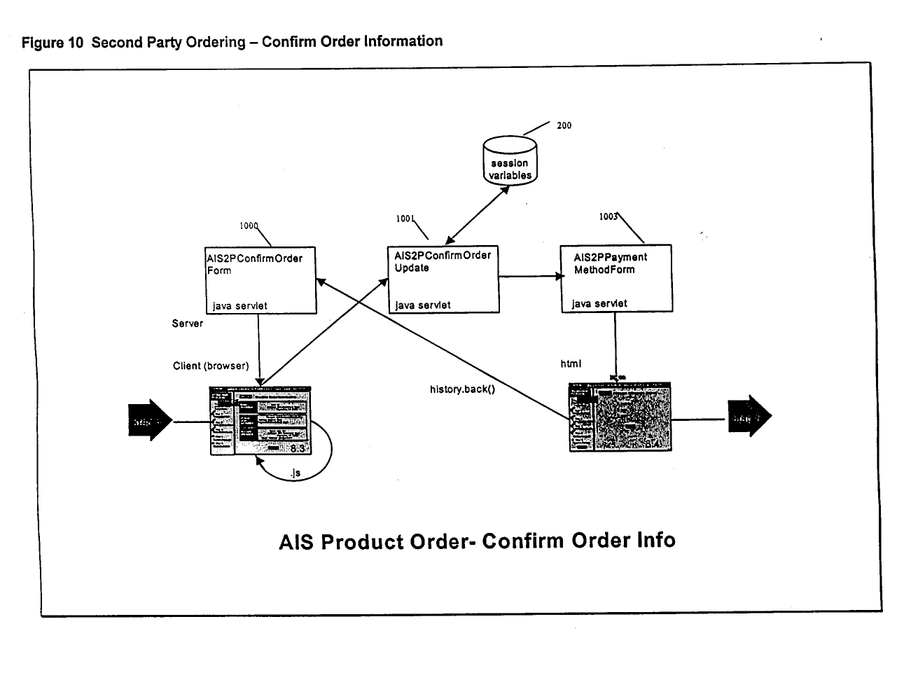

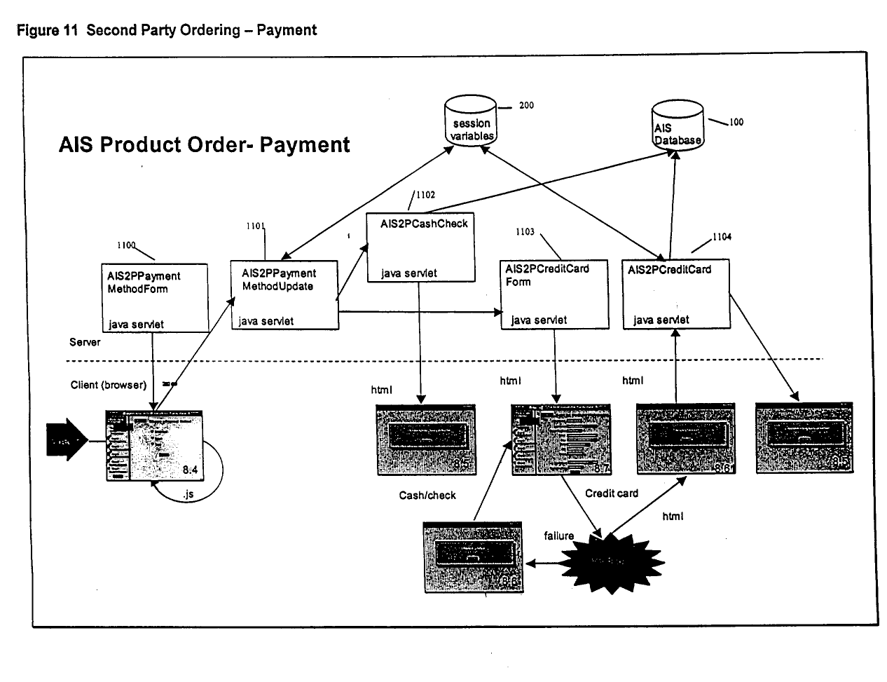

To order an Information Transaction Product 130, the User must identify the home according to the flow chart in FIG. 7 in a community association that is in the AIS Database 100. Once the home has been accurately identified, then the User can order an Information Transaction Product 130 using a product order form 800 according to the flow chart in FIG. 8. The User must also specify the Recipient who is to receive the Information Transaction Product 130 by using the Recipient Information form according to the flow chart in FIG. 9 . Before a payment is made by the User, the User is asked to confirm the product order for the Information Transaction Product 130 by using the form according to the flow chart in FIG. 10. A payment 180 can be made according to the flow chart in FIG. 11 using similar methods available in direct or First Party Ordering.

Once the User in the SPO has ordered and paid for the Information Transaction Product 130 , then the order appears on the Data Partner's password-protected part of the AIS Database 100 in the Prepared step 190P. The Data Partner then completes the process in the same manner as if the Data Partner had taken the product order as a First Party or direct order.

The User may wish to go online at the Data Partner's website and track the status 191 of the Information Transaction that was ordered according to the processing steps (190N, 190P, 190S, 190A and 1901, all in FIG. 2). This can be accomplished by the User login procedures as described.

The AIS System 10 adopts the existing classification or terminology used in the underwriting industry, the mortgage industry, the real estate industry, the housing insurance industry, and the title insurance industry. For example, the AIS System 10 adopts the underwriting classifications used by the secondary mortgage markets (FannieMae and FreddieMac).”

Via the above-described system and method, the invention facilities the Information Transactions for various community association industry segments which are involved in the Disclosure Process and the Lending Process.

Sellers Need To

1. Sell their home for the price they need and in the time required.

2. Meet statutory CA Disclosure Information requirements so the Buyer cannot use this as a reason to rescind the contract.

3. Meet other requirements of sale.

4. Find another place to live (rent or own).

AIS System Provides Sellers

1. Faster availability online of Information and supporting because management staff or CA volunteers can immediately input data without having to circulate documents—no unnecessary time delays for either the Seller or the Buyer.

2. AIS insured Guarantees against unexpected special assessments for prior sale for up to $5,000 if they have a signed listing agreement with a real estate broker or agent.

3. AIS insured Guarantees against unexpected special assessments after the sale will be made available to the Buyer, thereby minimizing the possibility disputes from the Buyer.

4. Ability to market the home in an association where the. mortgages are deemed eligible for possible purchase by secondary mortgage markets.

5. Searchable Database by street address and other attributes.

Buyers Need To

1. Make an informed decision about purchase by evaluating the housing services delivered by the association, especially whether

1.1 a special assessment or significant capital expenditure is likely,

1.2 there are reserves,

1.3 the association is involved in litigation and

1.4 there are life style restrictions and other rules & regulations that may impact their successful move and enjoyment of that community.

2. Obtain the required and necessary Disclosure Information or possibly decide to rescind the sales contract.

3. Provide multiple Lenders with necessary Lender Information in order to secure the most favorable mortgage.

4. Provide Lender Update Information, if needed, to the Lender prior to closing and later, if needed, by the Servicer.

5. Successfully complete the purchase of the home in the community association.

6. Successfully adapt to the lifestyle and various requirements of the community association

AIS System Provides Sellers

1. AIS insured Guarantees provide protection for up to $5,000 per year against errors in the Disclosure Information including unexpected and unanticipated special assessments.

2. Special Assessment protection can be extended for a second year.

3. Timely online availability of Disclosure Information and Lender Information that can be immediately sent to multiple parties and quickly updated.

4. Additional online information in Database to help make an informed purchase decision.

5. An initial preview as to whether their home mortgage may be eligible for possible purchase by the secondary mortgage markets (FannieMae or FreddieMac).

Self Managed CAs Without Site Staff Need

1. Provide Disclosure Information in a timely and efficient manner to the Seller (and others) to meet statutory disclosure requirements, in part, to avoid later complaints and problems with the Buyer.

2. Provide Lender Information and Lender Update Information if a mortgage or refinancing is involved in a timely and efficient manner.

3. Answer other questions that the Buyer (or Seller) or the Buyer's advisor(s) may raise.

4. Orient the new Buyer to the lifestyle and various requirements of the community association

5. Provide continual Update Information, if needed, by the Lender and/or Servicer.

6. Maintain and enhance home values in the community by helping to ensure the availability of mortgages.

7. Determine whom to contact, if a mortgage is involved, if the new owner is in default to the association.

AIS System Provides CAs Without Site Staff

1. Online Disclosure and Lender Information that further minimizes the need for volunteer Board members or committee members to be involved especially with Lender Update Information.

2. Insured Guarantees for any unintentional or accidental error in Disclosure Information protecting the community association and its Board of Directors for up to $5,000 per year per online Disclosure and Lender Information transaction. This will help minimize after-sale disputes.

3. Ability to answer certain questions of prospective Buyers through an online Database thereby further reducing the possibility of CA. members having to be directly involved.

4. Maintenance and enhancement of home values by determining and facilitating the eligibility of home mortgages for possible purchase by FreddieMac or FannieMae.

5. Availability of online information on the CA industry.

6. Participation in the improvement of the association industry.

CAs With Site Staff Need

1. Provide Disclosure Information in a timely and efficient manner to the Seller (and others) to meet statutory disclosure requirements, in part, to avoid later complaints and problems with the Buyer.

2. Provide Lender Information and Update Information if a mortgage or refinancing is involved in a timely and efficient manner.

3. Answer other questions from the Buyer (or Seller) or the Buyer's advisor(s).

4. Orient the new Buyer to the lifestyle and various requirements of the community.

5. Provide continual Update Information, if needed, by the Lender and/or Servicer.

6. Maintain and enhance home values in the community association by helping to ensure the availability of mortgages.

7. Determine whom to contact, if a mortgage is involved, if the new owner is in default to the association.

AIS System Provides CAs with Site Staff

1. Online Disclosure and Lender Information that facilitates office staff load balancing and reduces transaction fulfillment problems by being immediately available to all required parties including Update Information.

2. AIS insured Guarantees for an error in Disclosure Information protecting the CA Staff, the Buyer, the community and possibly the Seller from after-sale disputes for up to $5,000 per transaction.

3. Online credit card collection of Disclosure fees reducing staffing demands for accounting and record keeping.

4. Ability to answer certain questions of prospective Buyers through an online Database thereby further reducing demands on staff time.

5. Maintenance and enhancement of home values by determining and facilitating the eligibility of home mortgages for possible purchase by the secondary mortgage markets.

6. Availability of online information on CA industry.

7. Participation in the improvement of the association industry.

Real Estate Agents Need

1. Enable their user to successfully buy (or sell) their home in a PSI community.

2. Ensure that CA statutory disclosure requirements are met to (i) avoid sales contract rescission and (ii) later problems over incorrect Disclosure Information especially concerning the special assessments.

3. Assist their user in arranging the most favorable financing, if needed.

4. Minimize the time and effort required to obtain association Disclosure, Lender and Update Information.

5. Provide additional information to facilitate the sale/purchase.

6. Facilitate closing documentation and processing including obtaining Updates just before closing.

AIS System Provides Real Estate Agents

1. Faster availability of Disclosure, Lender and Update Information and supporting documents with no unnecessary time delays for a Seller or a Buyer plus the ability to track online the status of an order.

2. AIS insured Guarantees for their user.

3. Ability to market the home as the mortgage being eligible for possible purchase by secondary mortgage markets.

4. Possibility of becoming an Data Partner who can be compensated for providing online Disclosure, Lender and Update Information for self-managed CAs and who can provide Sellers in self-managed CAs with the AIS insured Guarantee for a Special Assessment.

5. Searchable AIS CA Database.

6. Availability of online information on CA industry.

7. Participation in the improvement of the association industry.

Other Professional CA Advisors Need

1. Review Disclosure and Lender Information and related documentation required in the sale/purchase of the home.

2. Assist their user in making an informed decision especially concerning the financial viability of the association.

3. Minimize the time and effort required to obtain association Disclosure and Lender Information.

4. Facilitate closing documentation and processing.

5. Participate in the improvement of the industry.

AIS System Provides Other CA Advisors

1. Online information to help their user make an informed purchase decision about the community association.

2. Knowledge of whether the home mortgage is eligible for possible purchase by secondary mortgage markets and what corrective actions might be taken to become eligible.

3. Availability of Guarantees for up to $5,000 with the possibility of an extension for an additional year.

4. Availability of online information on CA industry.

5. Participation in the improvement of the industry.

Mortgage Lenders, Mortgage Servicers, Title Companies and Escrow Companies Need

1. Process, underwrite and close or refinance a CA mortgage in a cost effective, cost efficient and profitable manner.

2. Evaluate the risk connected with that mortgage.

3. Obtain closing Update Information in a timely, effective and efficient manner.

4. Obtain credit enhancements for their mortgagor against special assessments, if available, especially in a state that has statutory lien priority protection for the association.

5. Prepare the mortgage for possible sale (or eventual sale) to secondary mortgage markets or evaluate to keep in portfolio.

6. Minimize risk from representations and warranties concerning the CA made to secondary mortgage markets.

7. Obtain Update Information in a more efficient manner after closing, especially if a default has occurred.

AIS System Provides Mortgage Lenders, Mortgage Servicers, Title Companies and Escrow Companies

1. Obtain online Lender, Disclosure and Update Information so that a home mortgage in a CA can be closed in a cost effective, cost efficient and profitable manner.

2. Credit enhancement available for the borrower and current owner in terms of AIS Insured Guarantees that include Special Assessment protection for one year and possibly two years from the date of purchase or transfer. These are assignable to the lender if the borrower defaults. These are also assignable to the Lender in lien priority states

3. Obtain CA Update Information in a timely, effective and efficient manner.

4. Better evaluate the credit risk a CA may pose to a low/moderate income Buyer or a senior seeking a reverse mortgage.

5. Match forbearance and delinquency tools to CA operations and risks by having better access to the association online.

6. Obtain online CA information to achieve better coordination with Servicers especially in the event of a default on a CA mortgage.

7. Better integrate CA Disclosure and Lender Information with personal mortgage information for packaging to the secondary mortgage markets.

8. Minimize risks from CA related FreddieMac representations and warranties.

9. Participation in the improvement of the industry.

Community Association Management (CAM) Companies Need

1. Meet statutory and management contract requirements to provide

1.1 Disclosure Information

1.2 Lender Information

1.3 Community Association Document Information and

1.4 Update Information

2. Minimize the time, effort and expense in providing this Information.

3. Generate ancillary income to offset the expense of providing Disclosure, Lender and Update Information as well as related information that may arise during the sale process even if no mortgage is involved or no sale takes place.

4. Generate other ancillary revenue.

5. Provide Update Information, if needed, to the Lender and/or Servicer.

6. Orient the new Buyer to the lifestyle and various requirements of CA life.

7. Determine whom to contact, if a mortgage is involved, if the new owner is in default to the association.

8. Link corporate profitability to the implementation of customer driven quality services based on superior employee performance.

AIS System Provides CAM Companies

1. Online Information that facilitates load balancing and reduces transaction fulfillment problems by being efficiently available to all required parties.

2. Allows Information order tracking to take place online minimizing repeated phone calls.

3. AIS insured Guarantees provide protection for an error in the Disclosure Information —this benefits the Buyer in the CAM managed community as well as the CAM as a company. The Seller may also be similarly protected.

4. Online credit card collection of Information fees reducing staffing demands, speeding up cash flow with credit card fees paid for and guaranteed by AIS.

5. Ability to answer certain questions of prospective Buyers and others through an online Database thereby further reducing demands on staff time.

6. Implementation of customer driven quality practices based on superior performance leading to better CAM profitability.

7. Enhanced position for a CAM as an industry leader and innovator in community association management.

8. Ability to advise CA on how to meet or maintain secondary mortgage market requirements thereby enhancing home values.

9. Availability of online information on CA industry.

10. Participation in the improvement of the CA industry.

Secondary Mortgage Markets Need

1. Purchase quality CA mortgage loans in a cost effective, cost efficient and profitable manner.

2. Obtain as much information as possible concerning the CA in an electronic and online format.

3. Evaluate the risk connect with that mortgage.

4. Obtain Disclosure, Lender and Update Information (as required) in a timely, effective and efficient manner.

5. Match forbearance and delinquency tools to CA operations and risks.

6. Coordinate the activities and functions of Servicers and Lenders in the event of a default on a CA mortgage.

7. Meet congressionally mandated housing goals that increasingly involve homes within community associations.

AIS System Provides Secondary Mortgage Markets

1. Purchase mortgage loans for homes in community associations in a cost effective, cost efficient and profitable manner with credit enhancements because of AIS Insured Guarantee.

2. Obtain Information in an electronic and online format because of the AIS Database.

3. Obtain Update Information in a timely, effective and efficient manner.

4. Obtain Update Information, if needed, after closing.

5. Determine how many loans are purchased in a given community association.

6. Ability to match forbearance and delinquency tools to CA operations and risks by having better access to the association through the AIS Database.

6. Better coordinate the activities and functions of Servicers, Lenders and, possibly, the CA in the event of a default on a CA mortgage.

7. Fulfill corporate goals and objectives especially as they apply to Low/Moderate Income borrowers and seniors seeking homes within CAs because of the information derived from the Database.

8. Participation in the improvement of the CA industry.

AIS Disclosure, Lender, Update, and Assessment/Covenant Reports

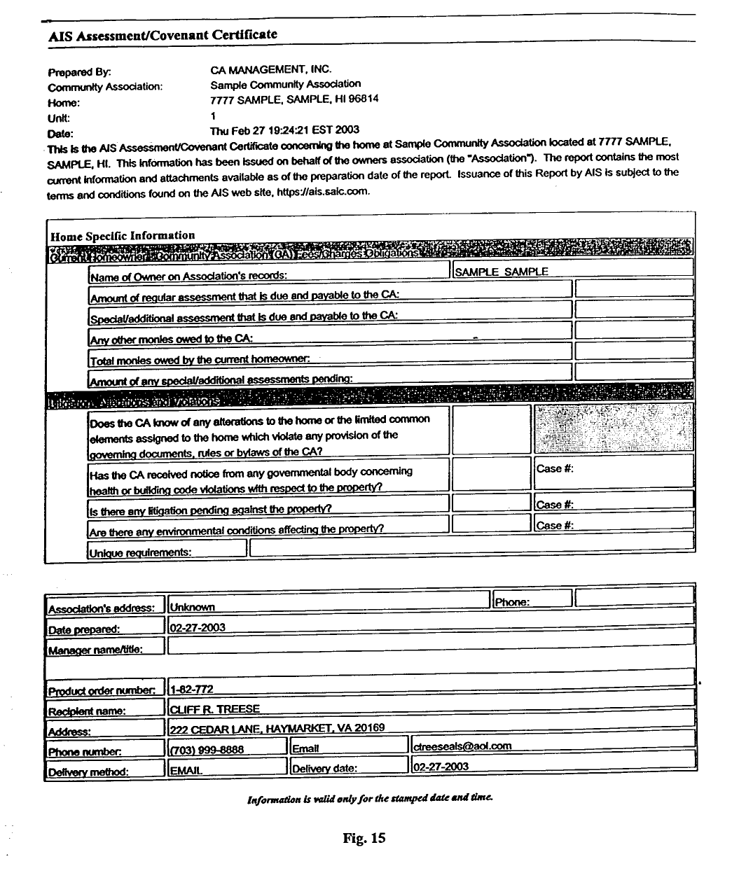

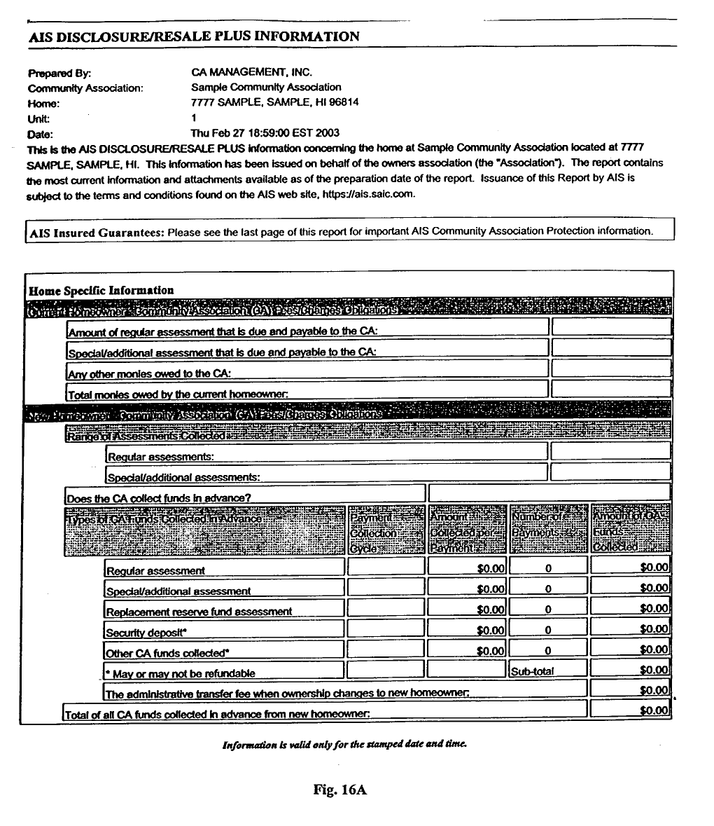

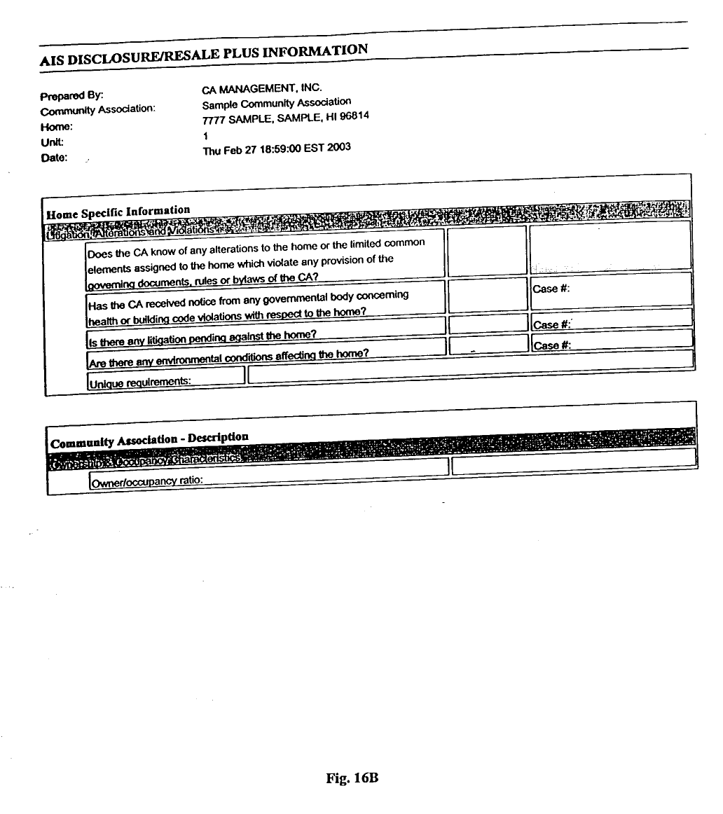

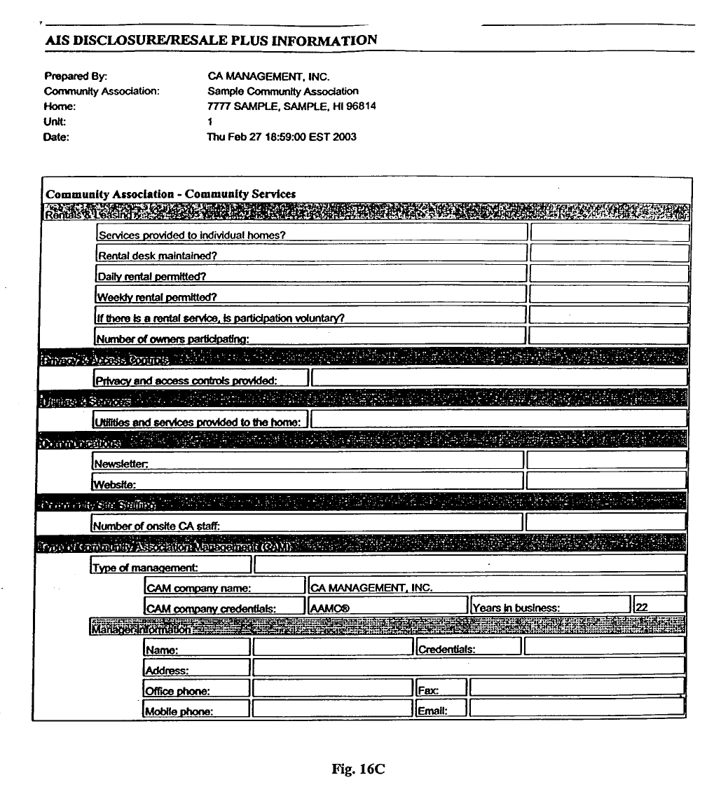

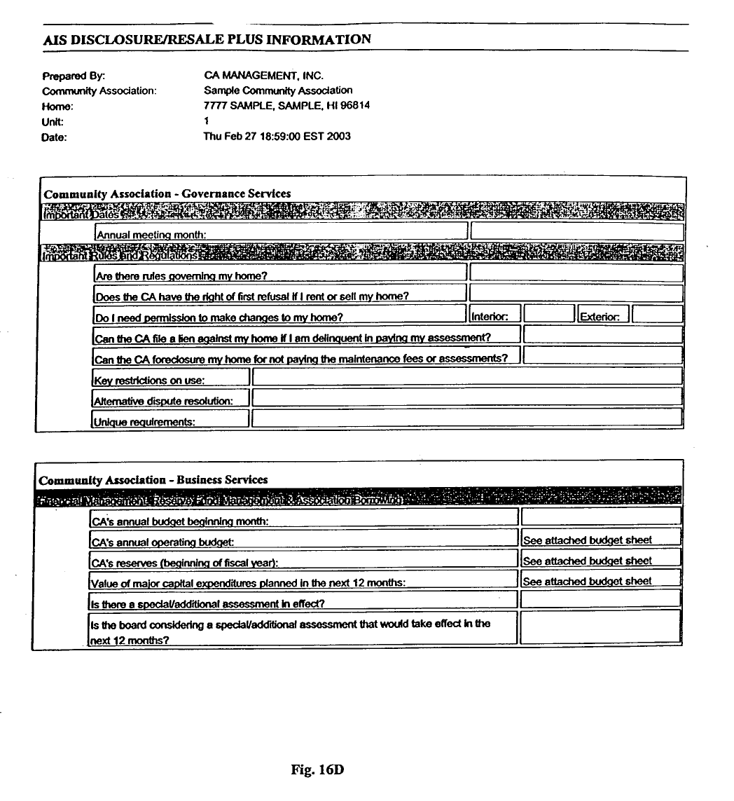

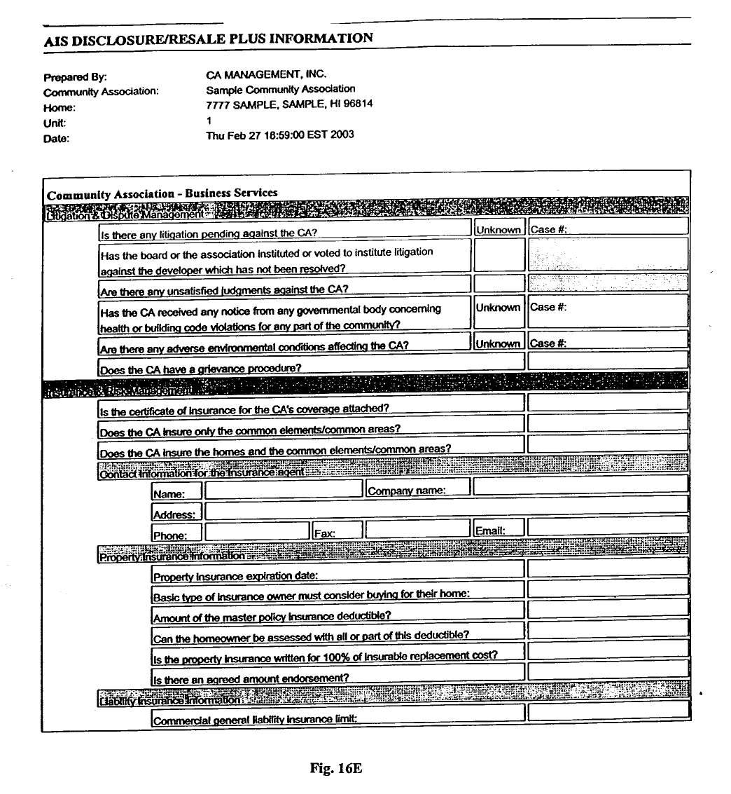

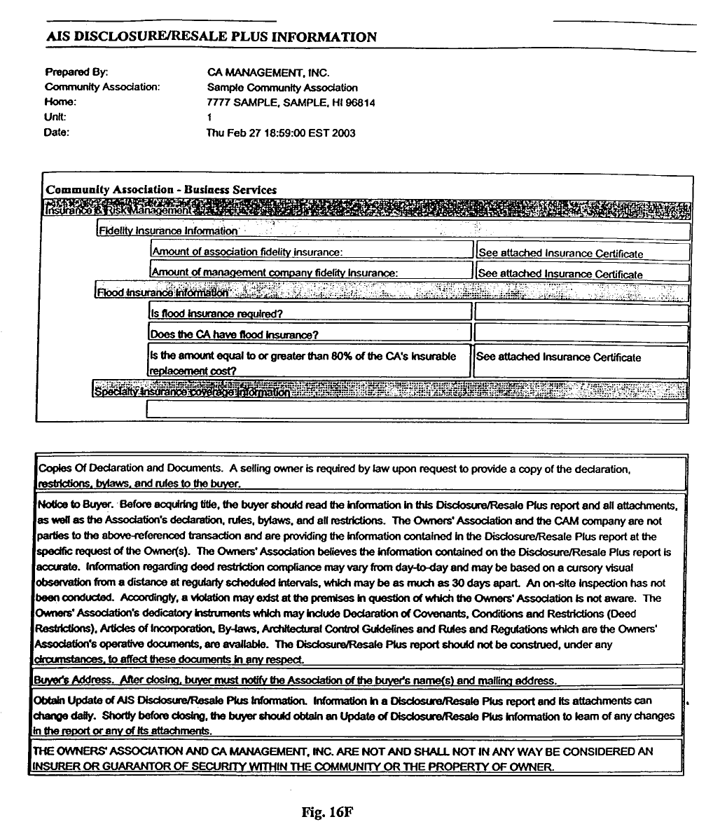

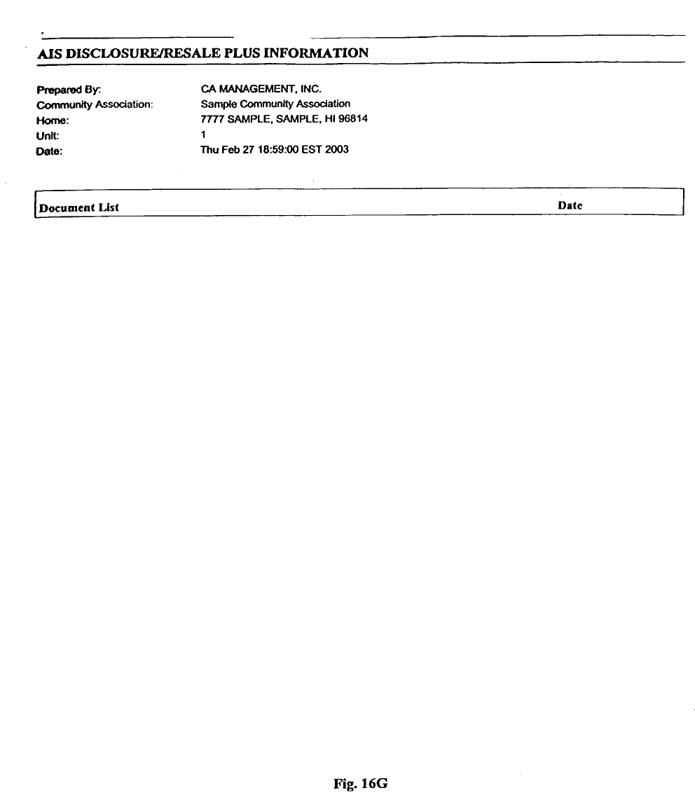

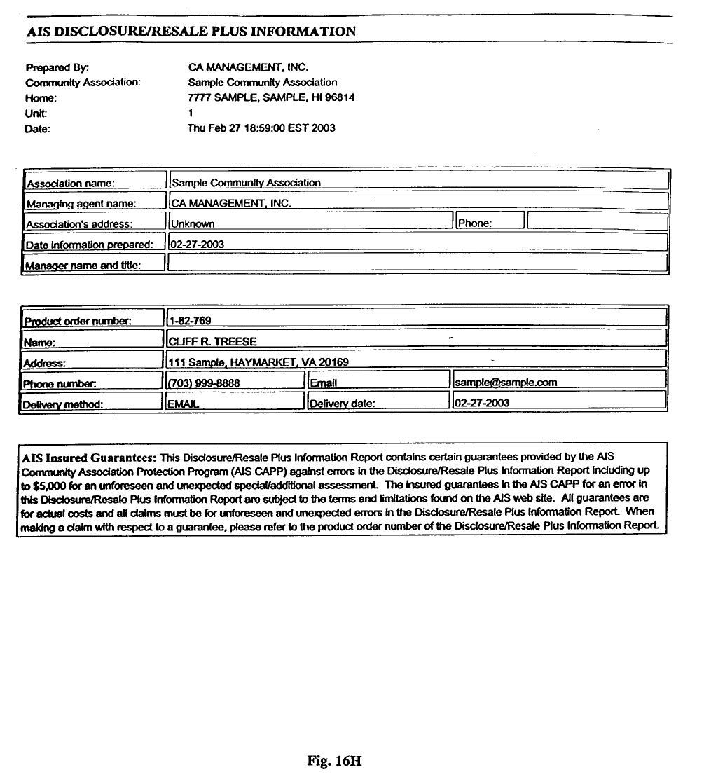

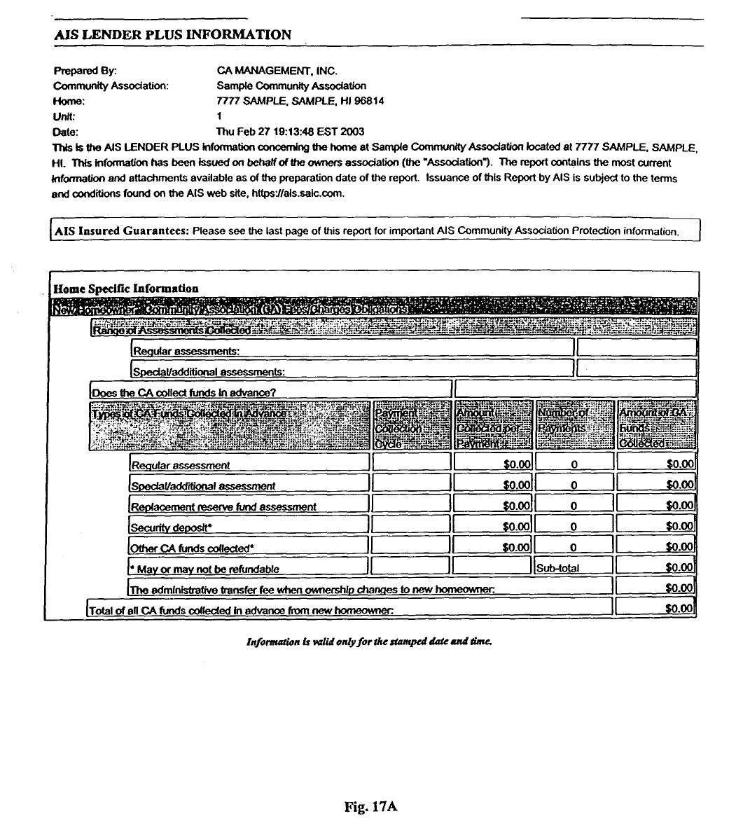

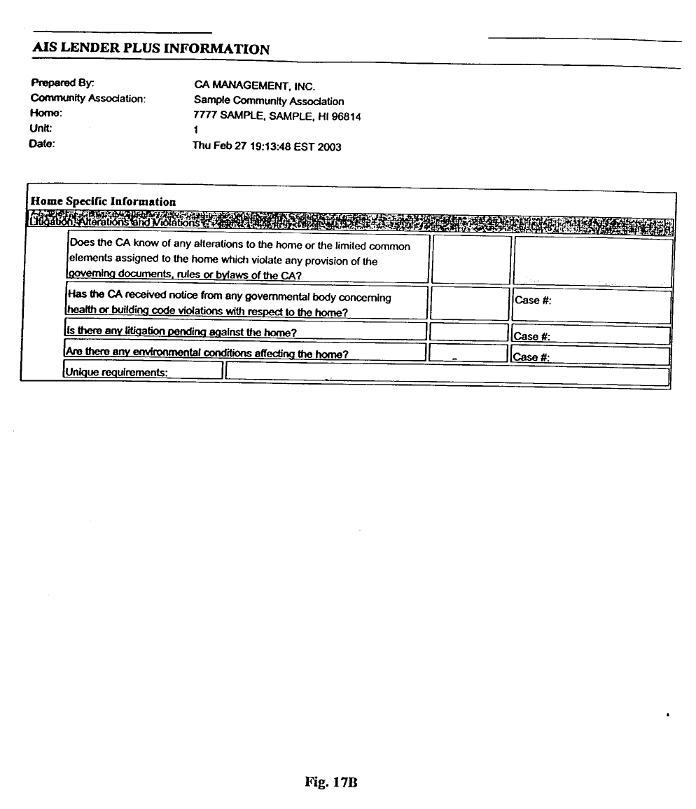

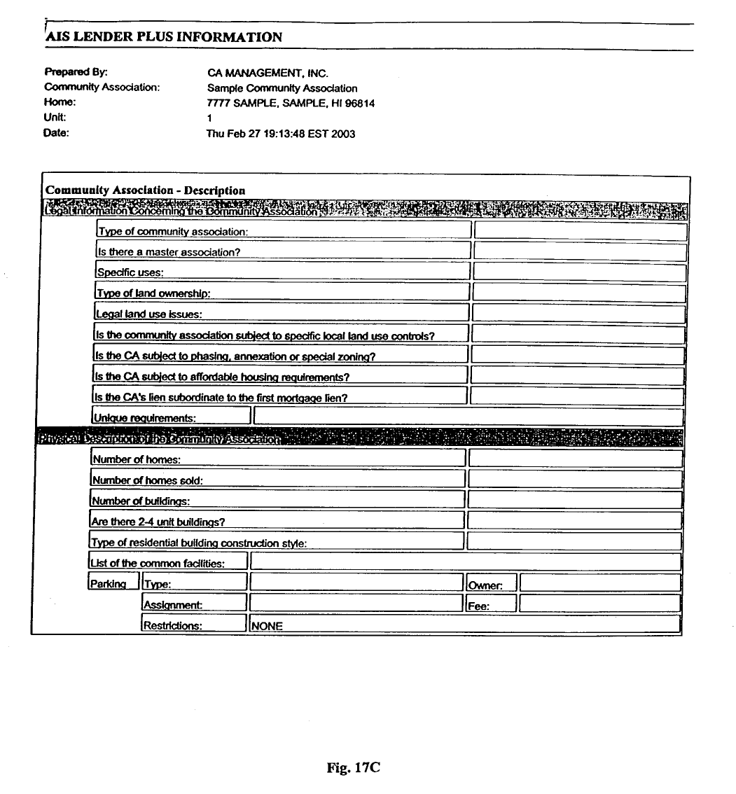

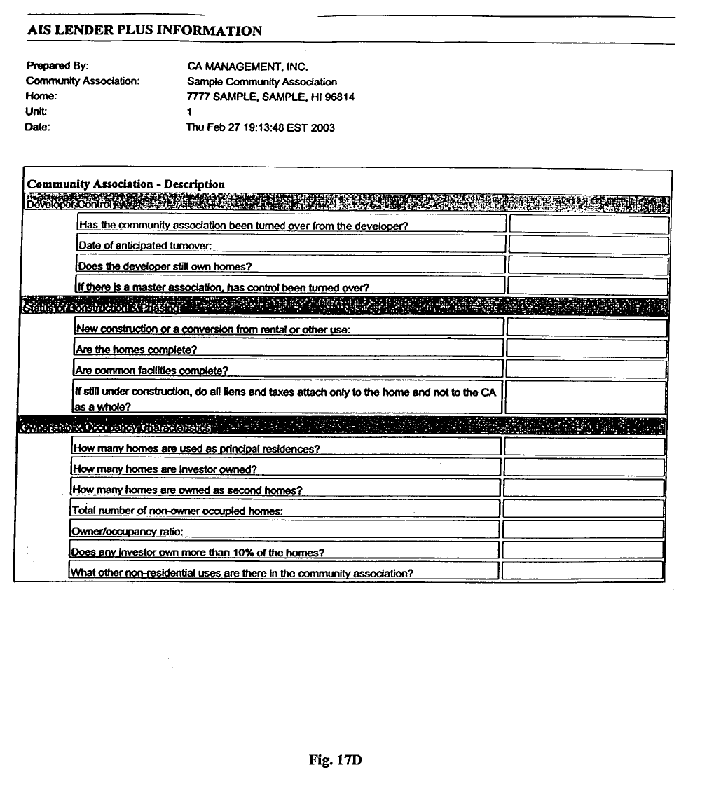

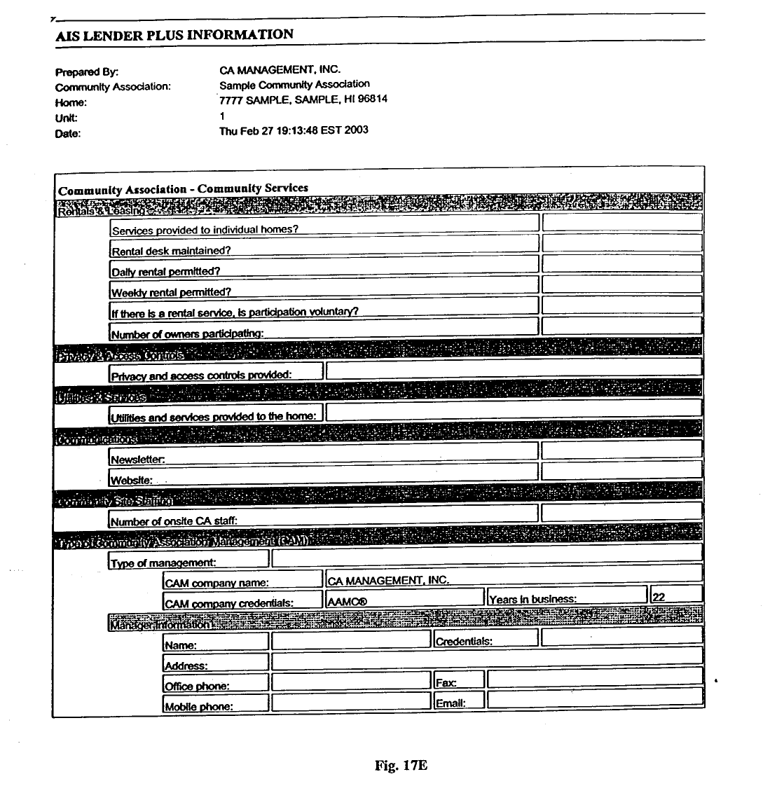

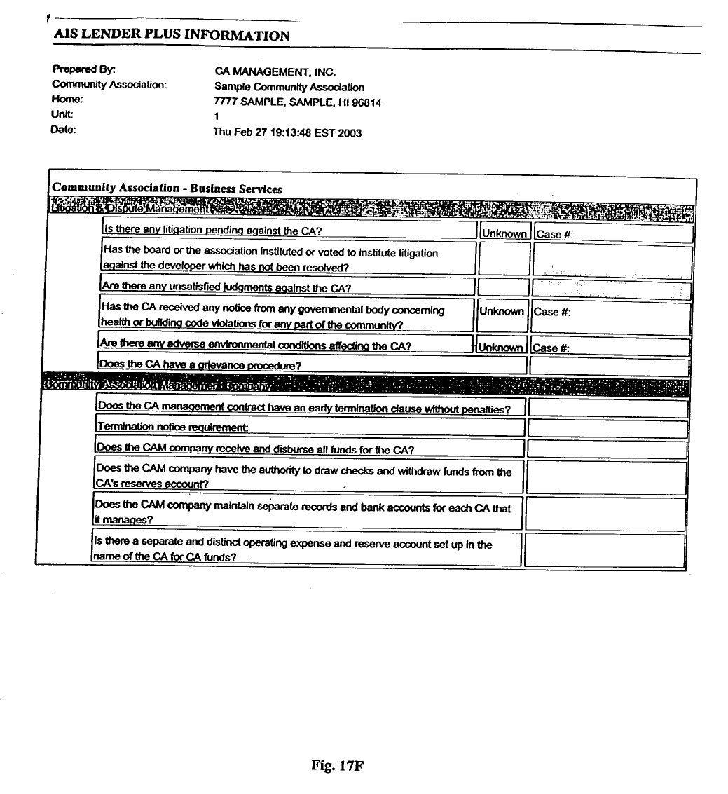

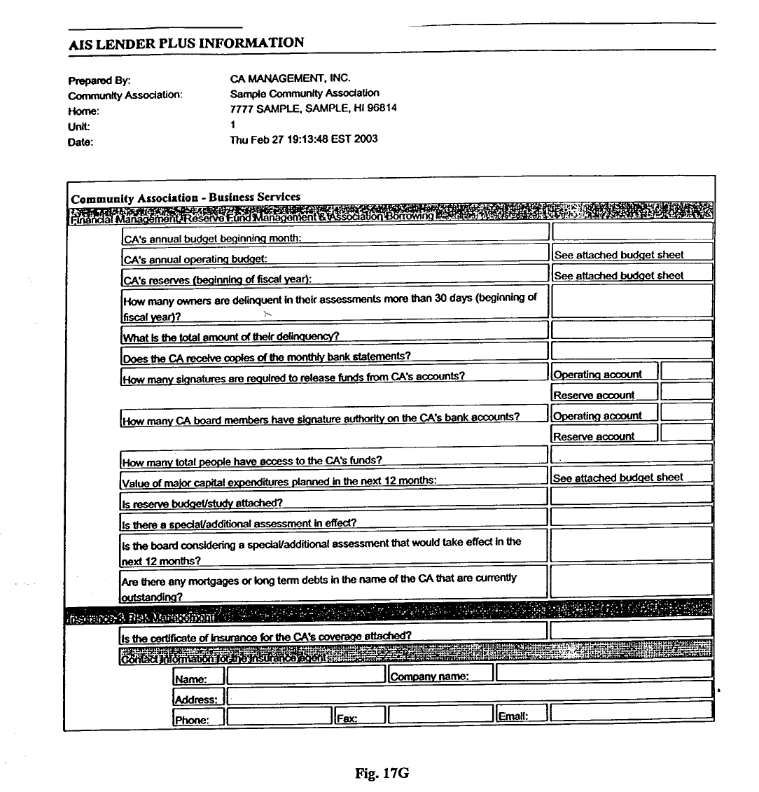

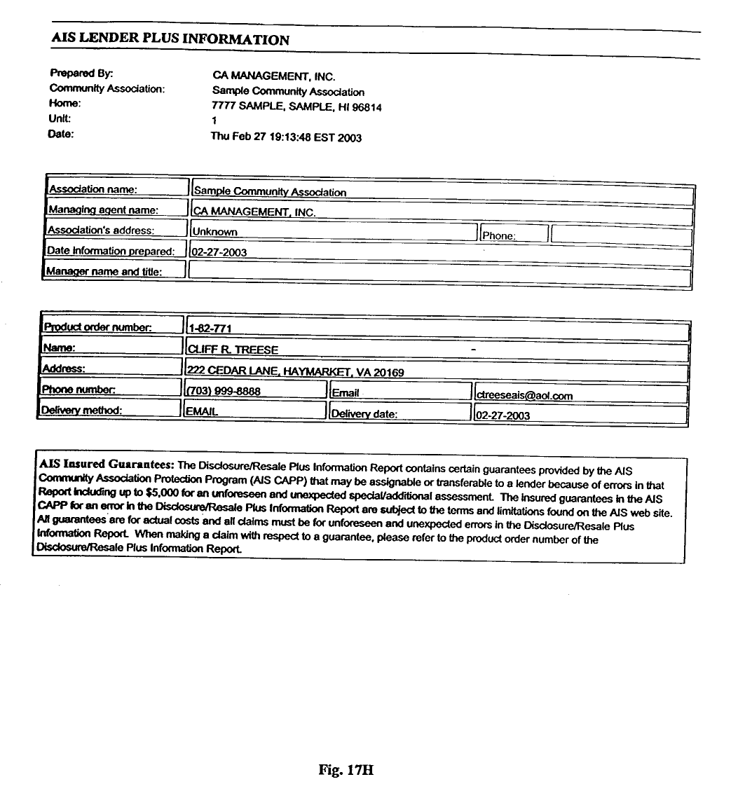

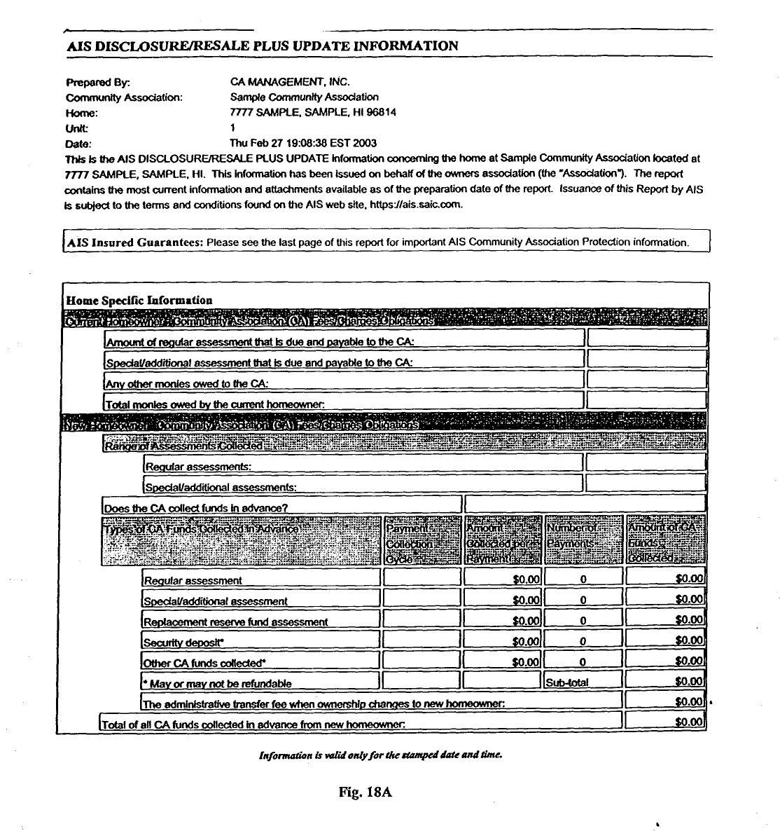

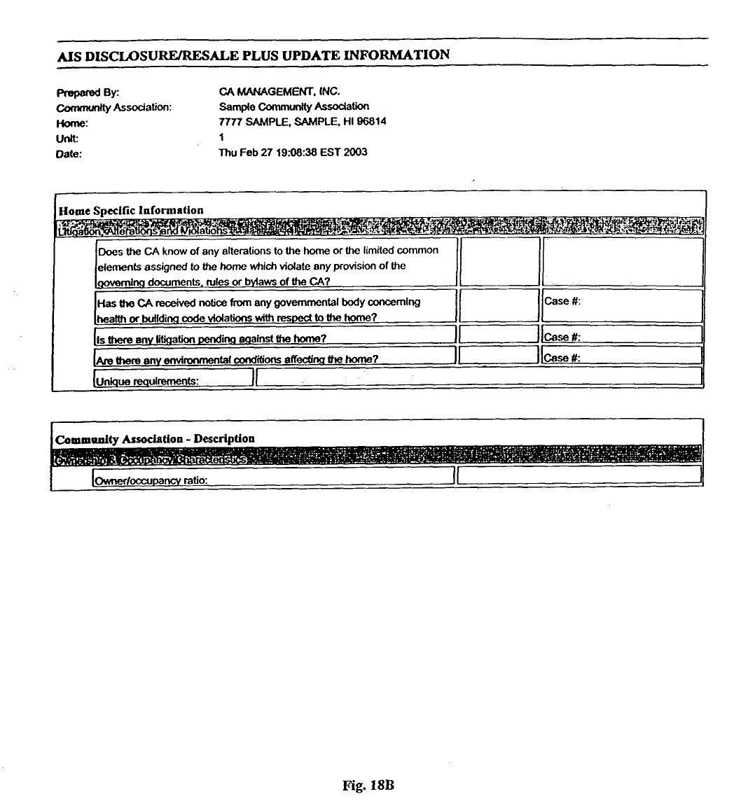

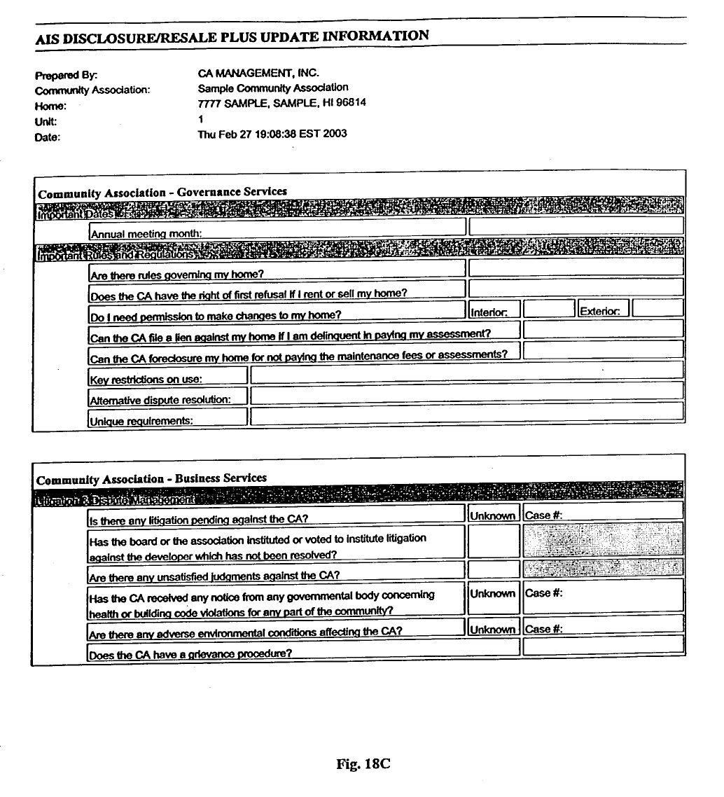

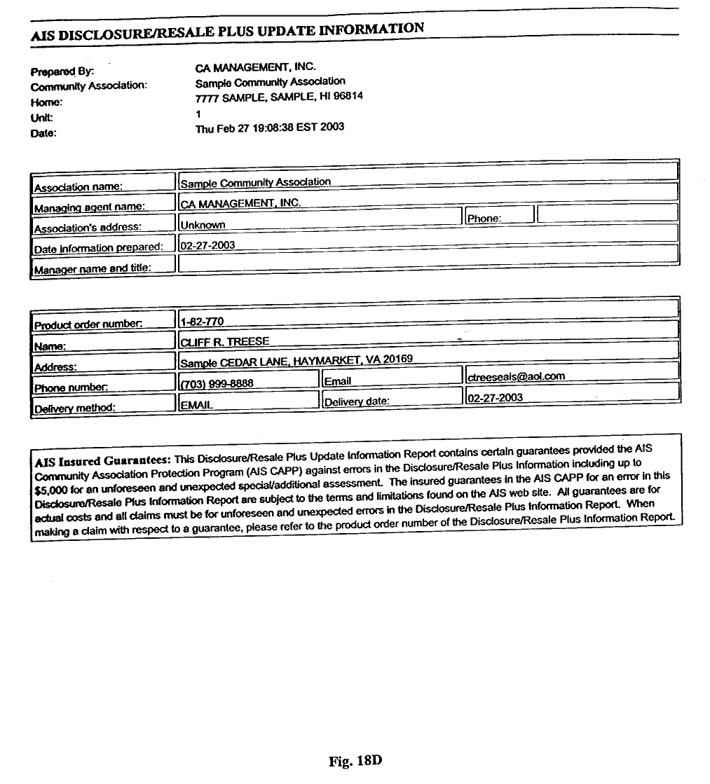

All of these AIS Reports are available via the Internet. Printed copies will also be available at the option of the AIS Data Partner. Examples of the four printed Reports are attached. Each of these four Reports also has attached all necessary community association documents. CA Documents (a separate category) is not a separate report per se, but is a packet of the association documents that can be ordered online and received online separately from the other four Reports. The Architectural/Covenant Inspection is a reporting element within the AIS Disclsoure Report and is available for an optional fee. Samples of the four Reports are shown in FIGS. 15-18. The one-page document in FIGS. 15 is a sample of AIS Assessment/Convenant Certificate according to the invention. The eight-page document in FIGS. 16A-H is a sample of AIS Disclosure/ResalePlus Information according to the invention. The eight-page document in FIGS. 17A-H is a sample of AIS Lender Plus Information according to the invention. The four-page document in FIGS. 18A-D is a sample of AIS Disclosure/Resale Plus Update Information according to the invention.

Secondary Mortgage Market Eligibility Evaluation

The AIS system 10 extracts from existing external databases, such as the AllRegs' Online Fannie Mae Single-Family Guides to store the FannieMae's eligibility criteria electronically in the CA database 100. The AIS system 10 also synchronizes the CA database 100 periodically with the external databases, such as the AllRegs' Online FannieMae Single-Family Guides thereby updating the FannieMae's eligibility criteria necessary to obtain a secondary mortgage loan.

Once the data was submitted by a user or a Data Partner, the AIS system 10 the user or the Data Partner can request the AIS system 10 to automatically evaluate the eligibility of a CA association thereby determining whether a community association meets the secondary mortgage market criteria for financing housing units in the CA association. In particular, Evaluation items are extracted from the eligibility criteria to be compared with the information of a CA association. In particular, all the Critical Items embedded in eligibility criteria are defined as Evaluation items to be extracted by the AIS system 10. For example, FannieMae requires 35% mortgage insurance coverage for a manually underwritten Fannie 97 mortgage (regardless of its term) according to VIII, 104.03 of the FannieMae Single-Family Guides. If the user or the Data Partner orders a FannieMae Single-Family Eligibility Evaluation, the AIS system 10 compares the mortgage insurance coverage % submitted by the user or the Data Partner with 35% stored in the CA database 100 to see whether the mortgage insurance coverage of the CA association is qualified so as to indicate a YES or NO. The actual requirement of 35% is also indicated in the Evaluation as a reference. All the evaluated items will be listed in a Secondary Mortgage Eligibility evaluation report for the user or the Data Partner to review so as to take appropriate actions.

The AIS system 10 allows an one-time user to order a Secondary Mortgage Market Eligibility Evaluation by answering a list of questions posted on an AIS webpage or a webpage of a Data Partner. One of the questions is about whether the one-time user authorizes the AIS system 10 to maintain the information entered by the user in the AIS database 100 so as to be available for other users or Data Partners.

Benchmarking

CAs present lenders with dual mortgage default scenarios which will only increase with time: (i) traditional default by the borrower because of non-payment of the mortgage itself, and (ii) CA-induced default because of non-payment of monthly assessments and/or violations of lifestyle and behavioral requirements of the association that may lead to fines, penalties and aggravating litigation. AIS's Community Association Database will build benchmarking or scoring indices to identify, for the first time, the conditions precedent to the second kind of default.

Credit Scoring

This Database, also, will facilitate the creation of scoring models so that CAs can be treated as collateral in the mortgage underwriting process assisting lenders and buyers in making better informed decisions.

AIS E-Commerce Community Association Strategies

The Database can also be used to pursue e-commerce opportunities such as the following:

An administrative fee is generated from the Guarantees.

AIS pursues an online marketing and underwriting agreement with for a specialty community association Directors and Officers Liability Insurance Program.

AIS develops with a provider for a community association home warranty program.

In a chart form, AIS would have these Business-to-Business (B2B) and these Business-to-Consumer (B2C) partners:

| B2B | | B2C |
|---|---|---|
| CAM Company | CIC as a corporate | Homeowners and renters (residents) who live |
| | entity acting through | in or own in a communiaty association |
| | its Board of Directors | |
| CAM Company Staff | CIC Resident | Managers and/or realtors ® who care for |
| | Manager (if any) | rented units on behalf of owners |
| Third Party Vendors | Third Party Vendors | Third party vendors or home service |
| who service the | who service the CIC | providers |
| CAM company | | |
| Professional Service | Professional Service | Professional service providers who advise |
| providers who advise | providers who advise | homeowners |
| the CAM Company | the CIC | |
| Financial Services: | Financial Services: | Financial Services: lenders, secondary |
| lenders, insurers | lenders (for common | mortgage markets, refinance companies, |
| (both P&C and | area loans), insurers | reverse mortgage companies, insurers for |
| AL&H) for the CAM | for the CA | personal lines products |
| company | | |
| | | Realtors ® who sell (or lease) units within a |
| | | CIC |
| | | Relocation companies |
| | | Home improvement & remodeling |
| | | contractors and product providers |
| | | Home care providers for the elderly |

CAM: Community Association Management Company
P&C: Property and Casualty Insurers
AL&H: Accident, Life & Health Insurers

The basic thrust of all initial AIS c-commerce endeavors, however, are in those areas that are strategically relevant to associations or their homeowners.

Insured Guarantees

An important part of the invention is the provision of insured Guarantees (Guarantees) which provide protection for certain errors in the Disclosure Process and Lending Process. These types of Guarantees do not exist in the community association industry. These Guarantees will be part of a community association protection program (CAPP) that the AIS Database system will use with the Information Transactions. The Gaurantees will be used with Disclosure/Resale Report.

The CAPP is the term for the insured guarantees that are designed to provide certain defined levels of protection for each of the seven Participants mentioned earlier who are in the disclosure process and the lending process. Four of the Participants receive full guarantees directly, one Participant may obtain a partial guarantee with qualifications; one Participant may purchase an extension of a partial guarantee and one Participant may receive a full guarantee as an assignment. While these distinctions are implicit in the ensuing material, it is helpful to summarize the features mentioned.

| | Type of | |
|---|---|---|
| Participant | Guarantee | Comments |
| 1. Buyer (for disclosure) | Full, Direct | Protection for an error in Disclosure &/or |
| | | Lending Process which might include an |
| | | unintended and unexpected special assessment, |
| | | an undiscovered covenant violation, etc. Lasts |
| | | for one year from the date of the Information is |
| | | ordered and paid for. If the Buyer orders and pays |
| | | for Update Information, then coverage runs from |
| | | that date. |
| 1. Buyer (for extension of | Partial, | Extension protection is only for an unexpected |
| additional year) | Optional | and unintended special assessment, if purchased, |
| | | for a period of one year after the expiration of the |
| | | first year Guarantee. |
| 2. Community Association and | Full, Direct | Protection for an error in Disclosure &/or |
| its Board of Directors | | Lending Process which might include an |
| | | unintended and unexpected special assessment, |
| | | an undiscovered covenant violation, etc. Lasts |
| | | for one year from the date the Information is |
| | | ordered and paid for or from the date the Update |
| | | Information is ordered and paid for. |
| 3. Community Manager or | Full, Direct | Protection for an error in Disclosure &/or |
| Management | (if present) | Lending Process which might include an |
| | | unintended and unexpected special assessment, |
| | | an undiscovered covenant violation, assessment |
| | | estoppel error, etc. Lasts for one year from the |
| | | date the Information is ordered and paid for or |
| | | from the date of the Update Information is |
| | | ordered and paid for. |
| 4. Real Estate Broker or | Full, Direct | Protection for an error in Disclosure &/or |
| Agent | (if present) | Lending Process which might include an |
| | | unintended and unexpected special assessment, |
| | | an undiscovered covenant violation, etc. Lasts |
| | | for one year from the date the Information is |
| | | ordered and paid for or from the date the Update |
| | | Information is ordered and paid for. |
| 5. Seller | Partial, | Protection only for an unintended and unexpected |
| | Qualifications | special assessment levied prior to sale if a listing |
| | | agreement is signed with a real estate broker or |
| | | agent who has registered with AIS and the |
| | | association is in the AIS Database. This |
| | | protection expires when the listing agreement |
| | | expires or when the home is sold or transferred to |
| | | a Buyer. |
| 6. Lender (financing a | Full, | This is not an additional Guarantee, but derives |
| mortgage) | Assignable | from an assignment of a Buyer's Guarantee if the |
| | | Buyer is in default to the mortgagee. |
| 7. Lender and Current Owner | Partial, | For the Current Owner: protection is only for an |
| (refinancing a mortgage) | Direct or | unintended and unexpected special assessment |
| | Assignable | that Lender Information is ordered and paid for to |
| | | complete a refinance. Protection is for one year |
| | | from the date of the refinance. For the Lender: |
| | | This is not an additional Guarantee, but derives |
| | | from an assignment of the Current Owner's |
| | | Guarantee if that Owner is in default to the |
| | | mortgagee |

The community association must be in the Database for any of the Participants to receive a Guarantee. In those cases where the Information must be updated prior to closing, AIS will provide Update Plus Information for which an additional fee may be charged. This may extend the duration of the insured guarantees for the Participants involved. In some jurisdictions, AIS will provide Information Transactions or Resale Packets separately from the insured Guarantees. In those jurisdictions, the CAPP will be sold separately. Nevertheless, the community association must be in the Database for any of the involved Participants to receive any of the Guarantees.

The CAPP guarantees are more fully described as follows. The following details of the CAPP use their own numbering and presentation format. The use bolded words and the use of trademark symbols are purely for illustration purposes.

AIS CAPP ™ Guarantee Information

1. AIS Services: AIS will prepare and deliver the AIS Report™. AIS has collected the necessary and required association governing documents, available financial records and related Information which are part of the Association Disclosure Process. This Information has been examined and has been entered into AIS's online database for analysis, comparison, verification and electronic transmission.

2. AIS Guarantees: As a result of that examination, AIS guarantees the accuracy of the Information set forth in the AIS Report™. AIS will pay losses incurred as a result of the inaccuracy of the Disclosure Information set forth in the AIS Report™, including unanticipated Special Assessments as detailed below.

3. Description of Four AIS CAPP™ Guarantees:Subject to certain eligibility requirements, limitations and exclusions (which are all detailed below and in subsequent sections), AIS makes the following four Guarantees:

| | |
|---|---|
| To the | Loss incurred up to $5,000 for a Special Assessment that is |
| Buyer | levied during the coverage period of the AIS Report ™. |
| | The Special Assessment may be levied by the Community |
| | Association, a Master Association or a Special Tax District |
| | created just for the community association. The maximum |
| | amount payable for all Special Assessments is $5,000. |
| To the | Loss incurred up to $5,000 for costs created by an |
| Community | error in the amount due and payable by the Seller as set |
| Association | forth in the AIS Report ™ and Resale Packet if issued |
| | separately. Similarly, the maximum amount payable |
| | regardless of the number of associations is $5,000. |
| To the | Loss incurred up to $5,000 for costs created by |
| CAM | an error in theAIS Report ™ and Resale |
| Company | |
| To the | Loss incurred up to $5,000 for costs created by an error in |
| Real | the AIS Report ™ in which the real estate broker or agent |
| Estate | played a role in assembling. This Guarantee is excess over |
| Broker | any insurance the real estate broker or agent may have |
| or Agent | for such errors. This Guarantee does not apply to any |
| | other disclosures made by the real estate broker or agent. |

AIS Insures the Following Obligations.

1. AIS CAPP™ Guarantee Eligibility—Applies to all Four AIS CAPP™ Guarantees, AIS Seller Special Assessment Guarantee Program™ and AIS Buyer Special Assessment Extension of Service Guarantee Program™

4.1 General Eligibility:

1. These Guarantees only apply if the amount claimed, to the Applicant's best available knowledge, is not the result of intentional conduct that could reasonably be expected to result in such a claim.

2. These Guarantees only apply to actual costs and damages sustained by one of the four listed participants in the Association Disclosure Process.

3. These Guarantees only apply to obligations required in the Association Disclosure Process and they do not apply to obligations under separate real estate disclosure statutes, regulations or contracts.

4. These Guarantees only apply to errors created in the good faith effort to comply with the Association Disclosure Process.

5. These Guarantees only become effective upon receipt by AIS of an online payment.

The AIS Seller Special Assessment Guarantee Program™ also requires the completion of an Online Application. If the Resale Packet is issued separately, then payment may be in two parts: one for the Resale Packet and the other for the AIS Report™ which includes the Guarantees.

6. The Guarantees are only included in the online AIS Report™ although the Resale Packet may be provided separately.

7. Under the terms given below, the AIS Seller Special Assessment Guarantee Program may be purchased separately.

8. To be eligible for the Guarantees, unless otherwise approved by AIS, the community association must be in existence for at least one year (whether new construction or conversion) and control of the Board of Directors must have transferred to the homeowners from the developer or declarant for at least one year.

9. AIS reserves the right, upon prior notice to the Buyer, to decline to issue the Guarantees as part of the AIS Report™.

4.2 AIS CAPP™ Guarantee Eligibility and Coverage Period—Buyer

1. The Buyer, or the person typical for the market area, must initiate the Association Disclosure Process which triggers the need for Information and the need for the AIS Report™ and Resale Packet, if issued separately.

2. The Buyer must pay AIS online when the AIS Report™ is ordered for the Guarantees to be in effect. There may be two payments if the Resale Packet is issued separately, one payment for the Resale Packet and one payment for the AIS Report™.

3. All of the Guarantees are effective for one year after the date of the AIS Report™.

4. The Buyer may request an AIS Update Report™ for an additional fee. AIS will extend the Guarantees for one year after the date of the AIS Update Report™ upon receipt of the online payment of the additional fee.

5. AIS Seller Special Assessment Guarantee Program™ Eligibility and Coverage Period—Purchased by Seller, Real Estate Broker or Agent, or Community Association

5.1 Seller—AIS Seller Special Assessment Guarantee Program™

1. The Seller may be eligible for the Special Assessment Guarantee Program™ (AIS Seller Guarantee Program™) upon completion by the Seller of an Online Application, online payment by the Seller to AIS and the agreement by the Seller, if required by AIS, to order the AIS Report™ for the Buyer at the appropriate time. The AIS Seller Special Assessment Guarantee Program™ is subject to the same limit ($5,000), terms and conditions as the other Guarantees.

2. For the Seller to purchase the AIS Seller Special Assessment Guarantee Program™, the Seller's community association must be current in the AIS Database as though an AIS Report™ had been issued and the Seller must pay AIS online.

3. To be eligible for the AIS Seller Special Assessment Guarantee Program™, unless otherwise approved by AIS, the Seller's community association must be in existence for at least one year (whether new construction or conversion) and control of the Board of Directors must have transferred to the homeowners from the developer or declarant for at least one year.

4. The AIS Seller Special Assessment Guarantee Program™ may be transferred to the Buyer for an additional fee.

5. The AIS Seller Special Assessment Guarantee Program™, after receipt of online payment and the Online Application, will remain in effect for one hundred and eighty days or until the date of the AIS Report™ whichever is earlier.

6. The Seller must, in good faith, intend to sell his or her home (or unit) and provide adequate evidence such as a signed listing agreement with a real estate broker or agent, a listing with a web-based real estate service or similar evidence typical of the sale of a home (or unit) in the geographic area in which the community association is located.

7. The Seller may transfer the cost of the AIS Seller Special Assessment Guarantee Program™ to the Buyer as a credit to the Buyer's AIS Report™ by notifying AIS at the time the AIS Report™ is ordered.

5.2 Real Estate Broker or Agent-AIS Seller Special Assessment Guarantee Program™

1. The real estate broker or agent may order the AIS Seller Guarantee Program™ on behalf of the Seller.

2. The same terms and conditions apply as though the Seller placed the order with AIS including the transfer of credit to the Buyer.

5.3 Community Association—AIS Seller Special Assessment Guarantee Program™

1. The community association may order the AIS Seller Guarantee Program™ on behalf of the Seller.

2. The same terms and conditions apply as though the Seller placed the order with AIS including the transfer of credit.

6. Exclusions—Applies to all Four AIS CAPP™ Guarantees, AIS Seller Special Assessment Guarantee Program™ and AIS Buyer Special Assessment Extension of Service Guarantee Program™

6.1. These Guarantees do not apply to costs created by intentionally committed errors in the Association Disclosure Process.

6.2. These Guarantees do not apply to anything other than actual costs.

6.3. These Guarantees do not apply to a knowing and willful failure to meet the requirements of an association's governing documents and policies, the knowing and willful failure to meet the requirements of local, state and federal law or the knowing and willful failure to meet residential mortgage industry requirements.

6.4. These Guarantees do not apply to special assessments, additional assessments or other costs that result from claims or litigation against the community association builder, developer, declarant or any successor.

6.5 These Guarantees do not apply to special assessments or other similar charges made by local or state taxing bodies other than Special Tax Districts set up specifically and exclusively for the community association.

6.6. These Guarantees do not apply to any special assessment levied for capital improvements which the Buyer or Seller consented to or voted to approve.

Claim Information

7. Claim Limitations—Applies to All Four AIS CAPP™ Guarantees, AIS Seller Special Assessment Guarantee Program™ and the AIS Buyer Special Assessment Extension of Service Guarantee Program™

7.1 The maximum amount payable for any of Guarantees is $5,000 regardless of the number or amount of claims during the period of eligibility.

7.2.1 All of the AIS CAPP™ Guarantees are effective for one year after the date of the AIS Report™.

7.3 The AIS Seller Special Assessment Guarantee Program™, after receipt of online payment and the Online Application, will remain in effect for one hundred and eighty days or until the AIS Report™ is ordered whichever is earlier

7.4 The amount of the claim for any of the AIS CAPP™ Guarantees and the AIS Seller Special Assessment Guarantee™ will be reduced by the amount of any insurance which is available to pay for that claim.

7.5 AIS reserves the right to recover the amount paid for any claim from the party causing the error other than the Buyer, Seller, CAM company or association manager, or real estate broker or agent.

7.6 The claimant assigns any rights of recovery to AIS against the party causing the error unless that person or entity is covered by the AIS CAPP Guarantees™ or the AIS Seller Guarantee Program™.

8. How to File a Claim—Applies to All Four AIS CAPP™ Guarantees, AIS Seller Special Assessment Guarantee Program™ and the AIS Buyer Special Assessment Extension of Service Guarantee Program™

8.1 Claims may be filed in one of four ways: (1) by completing the AIS Claim Form online at http://www.XXXXX.com/claims, (2) by downloading and mailing the claim form to Association Information Services at 1234 Lee Highway, (3) by downloading and faxing the claim form to AIS at 1-800-xxx-xxxx (3) by calling AIS at 1-800-xxxx.

8.2 Please use the AIS Report™ or AIS Seller Guarantee Program™ identification number when filing all claims. This identification number is also your password for the AIS Website.

9. Proof of a Claim—Applies to All Four CAPP™ Guarantees, AIS Seller Special Assessment Guarantee Program™ and the AIS Buyer Special Assessment Extension of Service Guarantee Program™

9.1 AIS may require submission of copies of the documents which detail the costs involved in proving the claim. AIS will allow such submission to be made online and with scanned documents.

9.2 AIS may require independent verification of the claim by third parties that AIS selects to investigate the claim.

10. Payment of a Claim—Applies to All Four AIS CAPP™ Guarantees, AIS Seller Special Assessment Guarantee Program™ and the AIS Buyer Special Assessment Extension of Service Guarantee Program™

10.1 For most claims, payment will be made within 30 days after submission of the claim form and any required supporting documentation and verification by third parties.

10.2 Payment will be made directly to one of the four participants listed under the Description of AIS CAPP™ Guarantees in the case of a AIS Report™ or to the Seller in the case of the AIS Seller Special Assessment Guarantee Program™.

General Information

11. Buyer Special Assessment Extension of Service—Applies Only to AIS Buyer Special Assessment Extension of Service Guarantee Program™

11.1 AIS may offer an extension of service to the Buyer with respect to the Special Assessment Guarantee part of the AIS CAPP™ Guarantees for an additional fee payable to AIS online. This extension to the Buyer is called the AIS Buyer Special Assessment Extension of Service Guarantee Program™.

11.2 Any such offer of the AIS Buyer Special Assessment Extension of Service Guarantee Program™ will be made to the Buyer prior to the expiration of the Buyer's AIS CAPP™ Guarantees.

11.2.1 To be eligible for renewal of the AIS Buyer Special Assessment Guarantee Program™, the Buyer's community association must be current in the AIS Database as though an AIS Report™ had been issued.

11.2.2 The AIS Buyer Special Assessment Guarantee Program™ is subject to the same limit ($5,000), terms and conditions as the other Guarantees

12. Cancellation and Refund—Applies to All Four CAPP™ Guarantees, AIS Seller Special Assessment Guarantee Program™ and the AIS Buyer Special Assessment Extension of Service Guarantee Program™

12.1.1 Once the AIS Report™ or the AIS Update Report™ has been prepared, AIS will make no refunds or prorations

12.2 There will be no refund or proration to the Seller for the AIS Seller Special Assessment Guarantee Program™ or to the Buyer for AIS Buyer Special Assessment Extension of Service Guarantee Program™.

12.3 AIS may cancel the AIS CAPP™ Guarantees in cases of fraud or misrepresentation by the claimant.

13. Transferability—Applies to All Four CAPP™ Guarantees, AIS Seller Special Assessment Guarantee Program™ and the AIS Buyer Special Assessment Extension of Service Guarantee Program™

13.1 These Guarantees are not transferable except as otherwise indicated without the prior written permission of AIS.

13.2 The Special Assessment Guarantee, whether as part of the AIS CAPP™, the AIS Seller Special Assessment Guarantee Program™ or the AIS Buyer Special Assessment Extension of Service Guarantee Program™ is automatically transferred to a foreclosing lender, if known by AIS, where the community association's assessment lien is superior to the mortgage or deed of trust.

13.3 The Special Assessment Guarantee, whether as part of AIS CAPP™, the AIS Seller Special Assessment Guarantee Program™ or the AIS Buyer Special Assessment Extension of Service Guarantee Program™ is automatically transferred to the community association foreclosing an assessment lien if the Special Assessment Guarantee is not transferred to a mortgage lender.

14. AIS Limitation of Liability

14.1 AIS's limit of liability for any error arising from the AIS Report™ or the AIS Update Report™, including the Guarantees, and the AIS Seller Special Assessment Guarantee Program™ and the AIS Buyer Special Assessment Extension of Service Guarantee Program™ is the limit of the actual costs and damages sustained, but in no event more than the limit of those Guarantees.

15. Governing Law and Alternative Dispute Resolution

15.1 If there is a disagreement about the coverage or applicability of an AIS Report™, AIS Update Report™, AIS CAPP™ Guarantees, the AIS Seller Special Assessment Guarantee Program™ or the AIS Buyer Special Assessment Extension of Service Guarantee Program™, AIS and the party making the claim shall use mediation to resolve the disagreement. The mediation will take place by telephone or online communication. If mediation fails, the disagreement will be resolved by binding arbitration conducted by the President (or President's designee) of the nearest Chapter of the Community Associations Institute (CAI). The cost of the arbitration will be divided equally unless otherwise determined by the arbitrator.

15.2 The validity, performance and construction of the AIS Report™, AIS Update Report™, AIS CAPP™ Guarantees, the AIS Seller Special Assessment Guarantee Program™ and the AIS Buyer Special Assessment Extension of Service Guarantee Program™, will be governed by the laws of the Commonwealth of Virginia.

16. Waiver

16.1 No failure of any party to exercise or enforce any of its rights with respect to the AIS Report™, AIS Update Report™, AIS CAPP™ Guarantees, the AIS Seller Special Assessment Guarantee Program™ and the AIS Buyer Special Assessment Extension of Service Guarantee Program™ will act as a waiver of those rights.

17. Definitions

actual costs

AIS Buyer Special Assessment Extension of Service Guarantee Program™

AIS Disclosure Plus Report™

AIS Disclosure Plus Update Report™

AIS Seller Special Assessment Guarantee Program™

additional assessment

architectural estoppel certificate

assessment estoppel certificate

association disclosure information

association disclosure process

association statutes

association related statutes

buyer

board of directors

community association

community association protection program (CAPP™)

community association management company

common interest development

condominium

cooperative

claim identification number

data partner

declarant

exclusions

governing documents

guarantee

home

information master association

password protection

planned community

process

purchaser

real estate broker or agent

real estate disclosure requirements

records

resale packet

residential mortgage industry

seller

special assessment

special tax district

transfer packet

unit

Update Report™

AIS Seller Special Assessment Guarantee Program ™

1. Application—AIS Seller Special Assessment Guarantee Program™

1. Applicant: Person or entity making the AIS Seller Special Assessment Guarantee Program™ Application on behalf of the Seller.

₁₃ Seller

₁₃ Real Estate Broker or Agent

₁₃ Community Association

2. Seller Identifying Information

Seller Name:

Community Association:

Unit Number:

Address:

Phone:

Fax:

Email:

AIS ID Number:

If other than Seller:

Name of Individual Completing the Application:

Name of Entity:

Address:

Phone:

Fax:

Email:

Website:

AIS ID Number:

3. Seller Intent to Sell Information

3.1 Listing Information

Listing Agent:

Name of Agent

Agency

Address

Phone

Fax

Email

Website

Listing Date:

Listing Expiration:

Expecting Closing Date:

3.2 Other For Sale Advertisement

Terms of Sale:

Placement Location and Duration

Placement #1 Duration

Placement #2 Duration

2. Fee—AIS Seller Special Assessment Guarantee Program™

2.1 Fee if the Seller's community association is in the AIS Database (as though an AIS Report™ had been requested): ______

2.2 Fee if the Seller's community association must be entered into the AIS Database: ______

2.3 Administrative Fee for Transfer to Buyer: ______

3. Mortgagee Transfer Information—AIS Seller Special Assessment Guarantee Program™

3.1 Contact information for Seller's first mortgagee of record.

3.2 Contact information for first Mortgage Servicer.

AIS Buyer Special Assessment Extension of Service
Guarantee Program ™

1. Offer—AIS Buyer Special Assessment Extension of Service Guarantee Program™

1. AIS offers to extend the Special Assessment Guarantee for a period of one year from its expiration.

2. This extension of service is subject to all of the terms and conditions of the original Special Assessment Guarantee.

3. Identifying Information

Buyer Name:

Community Association:

Unit Number:

Address:

Phone:

Fax:

Email:

AIS ID Number:

2. Fee AIS Buyer Special Assessment Guarantee Program™

2.1 Fee if the Seller's community association is in the AIS Database (as though an AIS Report™ had been requested): ______

2.2 Fee if the Seller's community association must be entered into the AIS Database: ______

2.3 Administrative Fee for Transfer to Buyer: ______

3. Mortgagee Transfer Information—AIS Buyer Special Assessment Guarantee Program™

3.1 Contact information for Buyer's mortgagee of record.

3.2 Contact information for first Mortgage Servicer.

AIS Disclosure Plus Update Report ™ Fee Schedule

1. Update fee for verification of Seller assessment status: ______

2. Update fee for verification of Seller architectural control compliance : ______

3. Update fee for AIS Update Report™: ______

AIS Technical Framework

Web Server: Apache HTTP Server—

The AIS web application uses the Apache HTTP Server to serve the HTML pages via the internet. The July 2002 Netcraft Web Server Survey found that 57% of the web sites on the Internet are using Apache, thus making it more widely used than all other web servers combined.

Application Server: Tomcat 4.0 Servlet/JSP Container—

The AIS web application uses the Tomcat Application Server to execute the Web Application Java™ Servlets. Tomcat is the servlet container that is used in the official Reference Implementation for the Java™ Servlet and JavaServer Pages™ technologies. Tomcat is developed in an open and participatory environment and released under the Apache Software License.

AIS Software:

Most of the AIS Software is written in Java™ language as Java™ Servlets. The user, through their browser, generates HTTP requests to execute Java™ Servlets. These requests are received by the Apache web server and directed to the Tomcat Applications Server. The executed Java™ Servlets contain the business logic to execute the AIS application. The Servlets dynamically generate the HTML response based on the business rules and the data retrieved from the AIS database. This HTML response is directed to the Apache HTTP server and returned to the user's browser.

AIS Database:

The AIS Program connects to the AIS database that is used for a persistent storage. The Java™ Servlets access the AIS database via the JDBC-ODBC bridge. The SQL to access the AIS database is dynamically constructed based on the submitted HTML Form Parameters and the Servlet business rules.

Javascript:

The HTML response contains dynamically generated Javascript scripts that are executed by the user's browser. The Javascripts provide for field validation, event monitoring (such as right-click disabling), and other user side features.

Authentication and Authorization:

The AIS web application uses database Authentication and Authorization. User id's and passwords are stored in the AIS database for each CAM. The CAM Admin User can assign roles that limit or modify access to the AIS web application.

Java™ Applets:

The AIS uses a single Java™ Applet to enable the “beep” sound when using the MS Internet Explorer.

Session Management:

The AIS system uses Session Objects that are generated by the Java™ Servlet Container for session management and state preservation. A session Id is created when a user successfully logs on to the AIS web application and is stored in a session object. The session Id is passed and stored on the user's browser. The stored session Id is used to maintain a session and expires after 30 minutes of inactivity or is expired on logout.

State Preservation:

The HTTP protocol is stateless. The AIS web application uses two techniques for maintaining state: Session Objects and Hidden variables. Session Objects are maintained during the user session and are removed at session expiration. Hidden variables are elements that are contained in an HTML form in the web page delivered to the user and displayed on the user's browser. The Hidden elements are returned to the AIS application when the user submits the form.

HTML Frames:

The AIS web application opens a separate browser window and uses HTML Frames to divide the new window into menu/title/tool and main frames. The menu/title/tool frames are stationery when the main frame is scrolled when viewing lengthy lists of data.

Dynamically Generated PDF documents:

The AIS Web Application uses a Java™ Servlet to dynamically generate a Disclosure/Lender/Update report in Adobe PDF format based on the data contained in the AIS database and guided by the AIS business rules. Additional Java™ classes are used to compress the documents to be emailed before they are sent.

Dynamically Generated MIME Multi-Part Emails:

The AIS web application uses a Java™ Servlet to dynamically generate emails that contains the Disclosure/Lender/Update report and associated Community Association documents as attachments and delivered via a SMTP server setup on the AIS server. Additional Java™ classes are used to compress (ZIP) the documents to be emailed before they are sent.

E-commerce Partners:

AIS has teamed with VeriSign and Merchant e-Solutions, as electronic commerce partners, to provide secure credit card transactions over the Internet. These sites employ certificate based server authentication to establish an encrypted Secured Socket Layer (SSL) session and to assure customers that they are dealing with a web site identified with a particular company. The encrypted SSL session ensures that personal information sent over the Internet, such as credit-card numbers, cannot easily be intercepted.

The principles, preferred embodiments and modes of operation of the present invention have been described in the foregoing specification. However, the invention which is intended to be protected is not limited to the particular embodiments disclosed. The embodiments described herein are illustrative rather than restrictive. Variations and changes may be made by one skilled in the art without departing from the spirit of the present invention. Accordingly, it is expressly intended that all such variations or changes which fall within the spirit and scope of the present invention as defined in the claims, be embraced thereby.

What is claimed is:

1. A method for providing information necessary to complete the sale, transfer, financing or refinancing of a housing unit in a community association or to manage the community association, the method comprising:
compiling CA information regarding a plurality of community associations into a CA database;
extracting said information necessary to complete the sale, transfer, financing or refinancing or to manage the community association from the CA database; and
providing to an authorized user said information necessary to complete the sale, transfer, financing or refinancing or to manage the community association.

2. The method according to claim 1, wherein said information necessary to complete the sale, transfer, financing or refinancing includes one of disclosure information, lender information, update information, CA document information, architectural/covenant inspection information, and assessment/covenant information.

3. The method according to claim 1, wherein the CA information includes at least one of: (1) outstanding capital expenditures, assessments, taxes, charges, or levy; (2) planned capital expenditures, assessments, taxes, charges, or levies; (3) nature of said capital expenditures, assessments, taxes, charges, or levies; (4) whether any legal actions are pending; and (5) special restrictions on use.

4. The method according to claim 3, wherein said capital expenditures, assessments, taxes, charges, or levies is imposed by a local or state governmental body, or a community association.

5. The method according to claim 3, wherein said special restrictions on use comprise architectural controls or covenants.

6. The method according to claim 1, further comprising a step of synchronizing at least one existing database with the CA database.

7. The method according to claim 6, wherein said existing database is a database developed and maintained by at least one of a local or state governmental body, a community association, the underwriting industry, the mortgage industry, the real estate industry, the housing insurance industry, and the title insurance industry.

8. The method according to claim 1, wherein said CA information is contained in declarations, bylaws, budgets, rules and regulations of said plurality of community associations.

9. The method according to claim 1, wherein the extracting step involves receiving a request for said information necessary to complete the sale, transfer, financing or refinancing or to manage the community association.

10. The method according to claim 1, wherein the extracting step involves receiving an application for the sale, transfer, financing or refinancing, and synchronizing the application with at least one existing database and the CA database thereby extracting said information necessary to complete the sale, transfer, financing or refinancing or to manage the community association from said at least one existing database and the CA database.

11. The method according to claim 1, further comprising a step of providing said information necessary to complete the sale, transfer, financing or refinancing in paper or in an electronic file.

12. The method according to claim 1, wherein the compiling step involves assigning an CA ID number for each of a plurality of community associations; assigning a UNIT ID number for each housing unit in said each of the plurality of community associations.

13. The method according to claim 1, further comprising a step of motivating a home inspector, a real estate professional, an appraiser, or a manager, a staff employee, or a member of the board of directors of said plurality of community associations in a CA database to provide the CA information.

14. The method according to claim 13, wherein the motivating step involves establishing a website posted with information helpful for completing the sale, transfer, financing or refinancing of a housing unit in a community association or for managing a community association thereby soliciting the home inspector, the real estate professional, the appraiser, or the manager, the staff employee, or the member of the board of directors of said plurality of community associations to provide the CA information.

15. The method according to claim 1, further comprising a step of establishing a data-sharing partnership among community associations, community association management company, real estate agents and brokers as data partners.

16. The method according to claim 1, wherein further comprising a step of certifying a payment by a potential user thereby authorizing the potential user as said authorized user.

17. The method according to claim 16, wherein the potential user is a owner or potential purchaser of the housing unit, a real estate broker or agent, a lender in the primary or secondary mortgage market, an accountant, reserve study specialists, an insurance agent, a manager or a member of the board of directors of a community association.

18. The method according to claim 1, wherein at least one of the steps is implemented by a computer.

19. The method according to claim 1, wherein the CA database is accessible on-line.

20. The method according to claim 1, further comprising a step of data-mining the CA information in the CA database thereby evaluating or benchmarking management efficiency of a community association.

21. The method according to claim 1, further comprising a step of data-mining the CA information in the CA database thereby facilitating the management of a community association.

22. The method according to claim 1, further comprising a step of providing an internet webpage to be accessed by a user so as to order said information necessary to complete the sale, transfer, financing or refinancing.

23. The method according to claim 14, further comprising a step of providing an internet webpage to be accessed by a user to order said information necessary to complete the sale, transfer, financing or refinancing, wherein the webpage is hosted by one of the data partners.

24. The method according to claim 1, further comprising a step of formatting said information necessary to complete the sale, transfer, financing or refinancing into a standard industry format or a summary format.

25. The method according to claim 1, further comprising a step of providing to the authorized user a guarantee for the accuracy of said information necessary to complete the sale, transfer, financing or refinancing or to manage the community association.

26. The method according to claim 25, wherein the guarantee is a limited guarantee.

27. The method according to claim 1, further comprising a step of collecting secondary mortgage market eligibility criteria, and evaluating a community association thereby determining whether the community association satisfies each of the eligibility criteria.

28. A computer-implemented method for evaluating whether a community association satisfies secondary mortgage market eligibility criteria, the method comprising:
collecting said secondary mortgage market eligibility criteria; and
comparing information of the community association thereby determining whether the community association satisfies each of the eligibility criteria

29. The method according to claim 28, further comprising a step of extracting at least one evaluation item from the eligibility criteria.

30. A system for providing information necessary to complete the sale, transfer, financing or refinancing of a housing unit in a community association, the method comprising:
means for compiling CA information regarding a plurality of community associations in a CA database;
means for extracting said information necessary to complete the sale, transfer, financing or refinancing form the CA database; and
means for providing to an authorized user said information necessary to complete the sale, transfer, financing or refinancing.

31. A computer software for providing information necessary to complete the sale, transfer, financing or refinancing of a housing unit in a community association, the method comprising:
a module for compiling CA information regarding a plurality of community associations in a CA database;
a module for extracting said information necessary to complete the sale, transfer, financing or refinancing form the CA database; and
a module for providing to an authorized user said information necessary to complete the sale, transfer, financing or refinancing.
